(19) United States
(12) Patent Application Publication
(10) Pub. No.: US 2026/0321710 A1
(43) Pub. Date: Oct. 15, 2026

(54) High Performance Cathodes for Sodium-ion Batteries and Batteries Using Such Cathodes

(71) Applicant: BATTELLE MEMORIAL INSTITUTE, Richland, WA (US)

(72) Inventors: MARCOS LUCERO, West Richland, WA (US); FREDRICK O. OMENYA, Richland, WA (US); XIAOLIN LI, Richland, WA (US); DAVID M. REED, Richland, WA (US)

(73) Assignee: BATTELLE MEMORIAL INSTITUTE, Richland, WA (US)

(21) Appl. No.: 19/648,648

(22) Filed: Apr. 15, 2026

Related U.S. Application Data
(60) Provisional application No. 63/789,232, filed on Apr. 15, 2025.

(51) Int. Cl. H01M 10/054; H01M 4/02; H01M 4/505

(52) U.S. Cl. CPC H01M 10/054; H01M 4/505; H01M 2004/028

(57) ABSTRACT

Embodiments provide layered sodium-ion oxide cathodes that include selected dopants or sodium-ion batteries themselves that include such cathodes. These cathodes have the advantage of utilizing abundant and low-cost elements while providing practical energy densities and lifetimes for sodium-ion batteries. These cathodes have a composition that may be generally represented by: A_{w}NaᵤMnₓNiᵥFe_{y}φ_{z}O₂, wherein (I) 0<=w<=0.1; (II) 0.6<=u<=1.0; (III) 0<=x<=0.6; (IV) 0<=v<0.4; (V) 0<=><=0.4; (VI) 0<z<=0.4; (VII) φ is at least one of Cu, Mg, Ti, Cr, Zn, Li, K, Ca, Al, Cr, B, Sn, Sb, V, Zr, Mo, Ru, Bi; and (VIII1) A, if present, is at least one of Ca, Li, K, or B; and (IX) z is greater than zero such that at least one dopant element of φ is present in the cathode.

### RELATED APPLICATIONS

This application claims benefit of U.S. Patent Application No. 63/789,232 filed Apr. 15, 2025. This referenced application is hereby incorporated herein by reference in its entirety.

### STATEMENT AS TO RIGHTS TO INVENTIONS MADE UNDER FEDERALLY-SPONSORED RESEARCH AND DEVELOPMENT

This invention was made with Government support under Contract DE-AC0576RL01830 awarded by the U.S. Department of Energy. The Government has certain rights in the invention.

### BACKGROUND OF THE INVENTION

### Field of the Invention

The invention generally relates to the field of sodium-ion battery technology and more particularly to layered sodium-ion oxide cathodes with compositions that reduce, smooth, or eliminate stepped voltage profiles associated with phase transitions during cycling.

### Background Information

There is currently a global effort to develop efficient and reliable sodium-ion battery (SIB) technology for a variety of applications. To be integrated into the fast-growing battery market, SIBs must achieve low-cost, long cycle life, and practical energy densities. To date, many reported sodium cathode materials utilize high quantities of expensive metals (e.g., Ni, Co etc.). Incorporating such metals leads to high cost which is a significant factor limiting the commercialization of SIBs. Furthermore, layered sodium-ion oxides can exhibit undesirable voltage profiles with multiple steps. These staircase-like voltage profiles are caused by phase transitions of the cathode active material upon cycling. The phase transitions result in enormous stresses on the cathodes eventually leading to crack formation and active material loss, which leads to rapid cell decay.

A need exists for lowering the cost of cathode material and a need exists for smoothing or eliminating stepped voltage profiles associated with phase transitions that occur during cycling of SIBs.

### SUMMARY

It is an object of some embodiments of the invention to smooth stepped voltage profiles associated with cathode material phase transitions that occur upon battery cycling.

It is an object of some embodiments of the invention to eliminate cathode material phase transitions during battery cycling.

It is an object of some embodiments of the invention to provide cathodes with reduced material cost.

It is an object of some embodiments of the invention to provide cathodes that use higher amounts of abundant, sustainable elements.

It is an object of some embodiments of the invention to provide sodium-ion batteries with enhanced cycling life.

It is an object of some embodiments of the invention to provide layered sodium-ion oxide cathodes that allow for excellent capacity, voltage, and cycle life.

It is an object of some embodiments of the invention to provide an improved sodium-ion battery (SIB) using a layered sodium-ion oxide cathode that provides improved operational properties to the battery.

Layered cathodes of various embodiments of the invention have crystalline lattices with distinct layers that predominantly accommodate either alkali metals or transition metals. Various dopants can be incorporated into each distinct layer which may lead to smaller amounts of these other metals being accommodated in each type of layer. These compositions may generally be represented by

A_{w}NaᵤMnₓNiᵥFe_{y}φ_{z}O₂,
wherein
   0<=w<=0.4;
   0.6<=u<=1.0;
   0.2<=X<=1;
   0<=v<=0.4;
   0<=y<=0.4;
   0<=z<=0.4;
wherein at least one 0<z<=0.4 or 0<w<=0.4; and
wherein
   φ is at least one of Cu, Mg, Ti, Cr, Zn, Li, K, Ca, Al, B, Sn, Sb, V, Zr, Mo, Ru, Bi; and
   A is at least one of Ca, Li, K, B;
   φ and A are place holders for elements located within separate layers of the crystalline lattice of the layered cathode, wherein; and φ may zero to one or more included elements and A may represent zero to one or more dopant elements.
   wherein z may be considered the sum of a plurality of “zᵢ”s such that z=Σzᵢ (e.g. z₁+z₂+ . . . +zₙ) when multiple different elements of φ are present wherein φ=φ1_{z1}φ2_{z2} . . . φN_{zn}, e.g. Cu_{z1}Mg_{z2} . . . . Ti_{zn}) with each value of zᵢ representing the amount of a specific φ element and wherein for each selected φ element that is present, the associated zᵢ value may be selected from the group of: (1) 0<zᵢ<=0.4, (2) 0<=zᵢ<=0.3, (3) 0<=zᵢ<=0.2, (4) (1) 0<zᵢ<=0.1, (5) 0.25<=zᵢ<=0.4, (6) 0.025<=zᵢ<=0.3, (7) 0.025<=zᵢ<=0.2, (8) 0.025<=zᵢ<=0.1, (9) 0.05<=zᵢ<=0.4, (10) 0.0.5<=zᵢ<=0.3, (11) 0.05<=zᵢ<=0.2, (12) an 0.05<zᵢ<=0.1.
   wherein w may be considered the sum of a plurality of “w”'s each associated with a different “A” (i.e., w=Σwᵢ (e.g. w₁+w₂+ . . . +wₙ) when multiple elements of A are present) with each value of wᵢ representing the amount of its specific “A” element.

In some variations of the various embodiments set forth in the generalized description of the previous paragraph, the values of x, v, y, and z may be selected to fit the condition that x+v+y+z=1.

In a first aspect of the invention a layered oxide SIB cathode comprises a layered crystalline structure formed of A_{w}NaᵤMnₓNiᵥFe_{y}φ_{z}O₂, wherein Na, Mn, Ni, Fe, and O represent elements; wherein 0<=w<=0.4; 0.6<=u<=1.0; 0.2<=x<=1; 0<=v<=0.4; 0<=y<=0.4; 0<=z<=0.4; wherein φ comprises at least one element selected from the group consisting of: (a) Cu, (b) Mg, (c) Ti, (d) Cr, (e) Zn, (f) Li, (g) K, (h) Ca, (i) Al, (j) B, (k) Sn, (I) Sb, (ml) V, (n) Zr, (o) Mo, (p) Ru, and (q) Bi; wherein A comprises at least one element selected from the group consisting of: (i) Ca, (ii) Li, (iii) K, and (iv) B; and wherein at least one of (1) z is greater than zero such that at least one element of the group of (a)-(q) is present, (2) w is greater than zero such that at least one element of group (i)-(iv) is present, or (3) both x and w are non-zero such that at least one element of group (a)-(q) and at least one element of group (i)-(iv) are present.

Numerous variations of the first aspect of the invention exist and include, for example: (1) x+v+y+z=1; (2) the first aspect or the first variation thereof wherein z does not equal zero for at least one element of the group of (a)-(q); (3) the first aspect or the first variation thereof wherein z does not equal zero for at least two elements of the group of (a)-(q); (4) the first aspect or the first variation thereof wherein z does not equal zero for at least three elements of the group of (a)-(q); (5) the first aspect or the first variation thereof wherein z does not equal zero for more than three elements of the group of (a)-(q); (6) the first aspect or any of the first-fifth variations thereof wherein w does not equal zero for at least one element of the group of (i)-(iv); (7) the first aspect or any of the first-fifth variations thereof wherein w does not equal zero for at least two elements of the group of (i)-(iv).

Numerous additional variations of the first aspect of the invention exist and include, for example: (8) the first variation or the first aspect thereof wherein A_{w}NaᵤMnₓNiᵥFe_{y}φ_{z}O₂ is selected from the group of: (A) A_{w}NaᵤMnₓNiᵥFe_{y}φ_{z}O₂, with w=0, with φ being Mg, and with z>0; (B) A_{w}NaᵤMnₓNiᵥFe_{y}φ_{z}O₂ with w=0, with φ=Cu, and with z>0; (C) A_{w}NaᵤMnₓNiᵥFe_{y}φ_{z}O₂ with w=0, with φ=Ti, and with z>0; (D) A_{w}NaᵤMnₓNiᵥFe_{y}φ_{z}O₂ with w=0 and with z being Cu_{z1}Mg_{z2}, and with z1>0 and z2>0; (E) A_{w}NaᵤMnₓNiᵥFe_{y}φ_{z}O₂ with w=0 and with φ_{z} being Cu_{z1}Ti_{z2}, and with z1>0 and z2>0; (F) A_{w}NaᵤMnₓNiᵥFe_{y}φ_{z}O₂ with w=0 and with φ_{z} being Mg_{z1}Ti_{z2}, and with z1>0 and z2>0; (G) A_{w}NaᵤMnₓNiᵥFe_{y}φ_{z}O₂ with w=0, and with φ_{z} being Cu_{z1}Mg_{z2}Ti_{z3}, and with z1>0, z2>0, and z3>0 (H); A_{w}NaᵤMnₓNiᵥFe_{y}φ_{z}O₂ with A=Li, with w>0, and with z=0; (I) A_{w}NaᵤMnₓNiᵥFe_{y}φ_{z}O₂ with A being Li, with w>0, with φ being Cu, and z>0, and (J) A_{w}NaᵤMnₓNiᵥFe_{y}φ2O₂ with A being Li, with w>0, with φ_{z} being Cu_{z1}Mg_{z2} and with z1>0, and z2>0; (9) the first aspect or the first variation thereof wherein A_{w}NaᵤMnₓNiᵥFe_{y}φ_{z}O₂ is selected from the group of: (A) Na_{0.85}Mn_{0.5}Ni_{0.3}Fe_{0.1}Mg_{0.1}O₂, with w=0, and with φ being Mg; (B) Na_{0.85}Mn_{0.5}Ni_{0.3}Fe_{0.1}Cu_{0.1}O₂ with w=0 and with φ=Cu; (C) Na_{0.85}Mn_{0.5}Ni_{0.3}Fe_{0.1}Ti_{0.1}O₂ with w=0 and with φ=Ti; (D) Na_{0.85}Mn_{0.5}Ni_{0.2}Fe_{0.1}Cu_{0.1}Mg_{0.1}O₂ with w=0 and with φ_{z} being Cu_{z1}Mg_{z2}; (E) Na_{0.85}Mn_{0.5}Ni_{0.2}Fe_{0.1}Cu_{0.1}Ti_{0.1}O₂ with w=0 and with φ_{z} being Cu_{z1}Ti_{z2}; (F) Na_{0.85}Mn_{0.5}Ni_{0.2}Fe_{0.1}Mg_{0.1}Ti_{0.1}O₂ with w=0 and with φ_{z} being Mg_{z1}Ti_{z2}; (G) Na_{0.85}Mn_{0.5}Ni_{0.2}Fe_{0.1}Mg_{0.05}Cu_{0.1}Ti_{0.05}O₂ with w=0 and φ_{z}=Mg_{0.05}Cu_{0.1}Ti_{0.05}O₂; (H) Na_{0.92}Mn_{0.5}Ni_{0.3}Fe_{0.1}Mg_{0.1}O₂, with w=0, and with φ being Mg; (I) Na_{0.92}Mn_{0.5}Ni_{0.3}Fe_{0.1}Cu_{0.1}O₂ with w=0 and with φ=Cu; (J) Na_{0.92}Mn_{0.5}Ni_{0.3}Fe_{0.1}Ti_{0.1}O₂ with w=0 and with φ=Ti; (K) Na_{0.92}Mn_{0.5}Ni_{0.2}Fe_{0.1}Cu_{0.1}Mg_{0.1}O₂ with w=0 and with φ_{z} being Cu_{z1}Mg_{z2}; (L) Li_{0.05}Na_{0.95}Mn_{0.5}Ni_{0.4}Fe_{0.1}O₂ with A=Li, w=0.05, and with z=0; (M) Li_{0.08}Na_{0.92}Mn_{0.5}Ni_{0.3}Fe_{0.1}Cu_{0.1}O₂ with A=Li, w=0.08, and with φ_{z} being Cu_{z}; and (N) Li_{0.08}Na_{0.92}Mn_{0.5}Ni_{0.2}Fe_{0.1}Cu_{0.1}Mg_{0.1}O₂ with A=Li, w=0.08, and with φ_{z} being Cu_{z1}Mg_{z2}; (10) the first aspect or the first variation thereof wherein z=z_{z1} (e.g., z=z₁+z₂+ . . . +zₙ), wherein zᵢ is non-zero for at least one selected element of (a)-(q) of the first aspect when φ=φ1_{z1} . . . φn_{zn}, wherein the value zᵢ for at least one non-zero zᵢ is within a range selected from the group of: (A) 0<zᵢ<=0.4, (B) 0<=zᵢ<=0.3, (C) 0<=zᵢ<=0.2, (D)(1) 0<zᵢ<=0.1, (E) 0.25<=zᵢ<=0.4, (F) 0.025<=zᵢ<=0.3, (G) 0.025<=zᵢ<=0.2, (H) 0.025<=zᵢ<=0.1, (1) 0.05<=zᵢ<=0.4, (J) 0.0.5<=zᵢ<=0.3, (K) 0.05<=zᵢ<=0.2, (L) an 0.05<zᵢ<=0.1; (11) the tenth variation of the first aspect wherein the at least one selected element of (a)-(q) is a plurality of elements of (a)-(q); (12) the first aspect or the first variation thereof wherein w=Σwᵢ (e.g., w=w₁+w₂+ . . . +wₙ), wherein wᵢ is non-zero for at least one selected element (i)-(iv) of the first aspect when A=A1_{w1} . . . An_{wn}, wherein wᵢ, for at least one non-zero wᵢ is within a range selected from the group of: (A) 0<wᵢ<=0.2, (B) 0<wᵢ<=0.1, (C) 0<wᵢ<=0.08, (D) 0<wᵢ<=0.05, (E) 0<wᵢ<=0.025; (F) 0.025<=wᵢ<=0.2, (G) 0.025<=wᵢ<=0.1; (H) 0.025<=wᵢ<=0.08; (i) 0.025<=wᵢ<=0.05; (j) 0.05<=wᵢ<=0.2; (k) 0.05<=wᵢ<=0.1, and (L) 0.05<=wᵢ<=0.08; (13) the twelfth variation of the first aspect wherein the at least one selected element of (i)-(iv) is a plurality of elements of (i)-(v); (14) the first aspect or any of the first to eleventh variations thereof wherein u is within a range selected from the group consisting of: (I) 0.6<=u<=1, (II) 0.6<=u<=0.95, (III) 0.6<=u<=0.92, (iv) 0.6<=u<=0.85, (v) 0.85<=u<=1.0, (vi) 0.85<=u<=0.95, (vii) 0.85<=u<=0.92, and (viii) 0.92<=u<=0.96; (15) the first aspect or any of the first to eleventh variations thereof x is within a range selected from the group consisting of: (I) 0.2<=x<=1; (II) 0.3<=x<=0.9, (III) 0.4<=x<=0.8; (IV) 0.4<=x<=0.7; (V) 0.4<=x<=0.6; and (VI) 0.45<=x<=0.55; (16) the first aspect or any of the first to eleventh variations thereof wherein v is within a range selected from the group consisting of: (I) 0<=v<=0.4; (II) 0.05<=v<=0.35; (III) 0.05<=v<=0.3; (III) 0.05<=v<=0.25; (IV) 0.5<=v<=0.2; (V) 0.5<=v<=0.15; (VI) 0.1<=v<=0.4; (VII) 0.1<=v<=0.35; (VIII) 0.1<=v<=0.3; (VIII) 0.1<=v<=0.25; (IX) 0.1<=v<=0.2; (X) 0.15<=v<=0.35; (XI) 0.15<=v<=0.3; (XII) 0.15<=v<=0.25; (XIII) 0.2<=v<=0.35; (XIV) 0.2<=v<=0.3; and (XV) 0.25<=v<=0.35; (17) the first aspect or any of the first to eleventh variations thereof wherein y is within a range selected from the group consisting of: (1) 0<=y<=0.4; (II) 0.05<=y<=0.35; (III) 0.05<=y<=0.3; (III) 0.05<=y<=0.25; (IV) 0.5<=y<=0.2; and (V) 0.5<=y<=0.15.

In a second aspect of the invention, a sodium-ion battery, includes: (a) an anode; (b) a layered oxide cathode of the first aspect or of any of the first to seventeenth variations thereof; (c) an electrolyte; and (d) a separator.

Numerous variations of the second aspect of the invention exist and include, for example, the battery having a cathode selected from any specific one of the first aspect or any of its first to fifteenth variations or any functional combinations of such variations.

Other objects and advantages of various aspects and embodiments of the invention will be apparent to those of skill in the art upon review of the teachings herein. The various aspects and embodiments of the invention, set forth explicitly herein or otherwise ascertained from the teachings herein, may address any one of the above objects alone or in combination, or alternatively may address some other object of the invention ascertained from the teachings herein. It is not intended that any specific aspect or embodiment of the invention (that is explicitly set forth herein or that is ascertained from the teachings herein) necessarily address any of the objects set forth above let alone address all these objects simultaneously, but some aspects and embodiments may address more than one of these objects simultaneously.

### BRIEF DESCRIPTION OF THE DRAWINGS

FIG. 1A provides cycling performance (cycling stability) plots for seven different layered oxide cathode materials forming a first group of cathode materials synthesized at 900° C. with each having compositions of NaᵤMnₓNiᵥFe_{y}φ_{z}O₂ and more particularly compositions of Na_{u=0.85}Mn_{x=0.5}NiᵥFe_{y=0.1}φ_{z}O₂ where φ_{z} represents zero to three dopant elements with each present in an amount that is specific to it for each variation.

FIG. 1B, divided into two separate plots, provides 5th cycle voltage profiles of the layered cathodes of FIG. 1A measured over a 2-4 V vs. Na⁺/Na voltage window such that voltage changes and particularly voltage steps (or lack of steps) associated with the different cathode materials can be seen.

FIG. 1C provides Cu Kα Powder X-ray diffractogram (XRD) patterns for the layered oxide cathodes of FIGS. 1A and 1B.

FIG. 2A provides a synthesis phase diagram for cathodes having the general formula NaᵤMn_{0.5}NiᵥFe_{0.1}φ_{z=0.4}φᵥO₂ wherein φ_{z} is Mg_{z1}+Cu_{z2}+Ti_{z3}, wherein 0<=z<0.2, and z=z1+z2+z3=0.4−v, wherein the sintering temperature was 900° C. and wherein the vertical axis represents v from 0.2 to 0.4 and the horizontal axis represents u from 0.85 to 1.0.

FIG. 2B provides an expanded diagram for Na_{0.85}Mn_{0.5}Ni_{v=0.3}Fe_{0.1}φ_{z}O₂ wherein φ_{z} is more specifically Mg_{z1}Cu_{z2}Ti_{z3}=0 or more simply Mg_{z1}Cu_{z2} with synthesis occurring using a sintering temperature of 900° C., the vertical axis represents z2 while the horizontal axis represents z1, and wherein z=z1+z2=0.1.

FIG. 2C provides an expanded diagram for Na_{0.85}Mn_{0.5}Ni_{v=0.2}Fe_{0.1}φ_{z}O₂ wherein φ_{z} is more specifically Mg_{z1}Cu_{z2}Ti_{z3} with synthesis occurring based on a sintering temperature of 900° C., wherein the horizontal axes represent z2 and z1 while the vertical axis represents z3, and wherein z=z1+z2+z3=0.2.

FIG. 3A provides cycling performance (cycling stability) plots for four different layered oxide cathode materials forming a second group of cathode materials synthesized at 900° C. with each having a composition of Na_{0.92}Mn_{0.5}NiᵥFe_{0.1}φ_{z}O₂ or more specifically Na_{0.92}Mn_{0.5}NiᵥFe_{0.1}Cu_{z1}Mg_{z2}O₂ where z1 and z2 represent a 0.0 or 0.1 molar fraction amount in the different variations.

FIG. 3B provides 5th cycle voltage profiles of the layered oxide cathodes of FIG. 3A measured over a 2-4 V vs. Na⁺/Na voltage window during charging and discharging such that voltage changes and particularly voltage steps (or lack of steps) associated with the different cathode materials can be seen.

FIG. 3C provides Cu Kα powder X-ray diffractogram (XRD) patterns for the layered oxide cathodes of FIGS. 3A and 3B.

FIG. 4 provides a diagram for Na_{0.92}Mn_{0.5}Ni_{v=0.3}Fe_{0.1}φ_{z}O₂ wherein φ_{z} is more specifically Cu_{z1}Mg_{z1}Ti_{z3}=0 or more simply Cu_{z1}Mg_{z2}, wherein z1+z2=0.1, wherein synthesis occurs using a sintering temperature of 900° C., and wherein the vertical axis represents z2 from 0.00 to 0.10 while the horizontal axis represents z1 from 0.00 to 0.10.

FIG. 5A provides cycling performance (cycling stability) plots of specific capacity for six different layered oxide cathode materials forming a third group of cathode materials synthesized at 1000° with each having a composition of Na_{0.85}Mn_{0.5}NiᵥFe_{0.1}φ_{z}O₂ wherein Oz represents zero to two dopants selected from the group of Mg, Cu, and Ti with each present in a molar fraction amount corresponding to values shown in the formulas of FIG. 5A.

FIG. 5B provides 5th cycle voltage profiles of the layered oxide cathodes of FIG. 5A measured versus specific capacity during charging and discharging such that voltage changes and particularly voltage steps (or lack of steps) associated with the different cathode materials can be seen.

FIG. 5C provides Cu Kα powder X-ray diffractogram XRD patterns for layered oxide cathodes of FIGS. 5A and 5B.

FIG. 6A provides a synthesis phase diagram for cathodes with the general formula of NaᵤMn_{0.5}NiᵥFe_{0.1}φ_{z}O₂ sintered at 1000° C., wherein φ represents possible dopants and z represents a sum of the quantities of such dopants expressed as molar fractions.

FIG. 6B provides an expanded diagram for Na_{0.85}Mn_{0.5}Ni_{0.3}Fe_{0.1}φ_{z}O₂, wherein φ_{z} is more specifically Cu_{z1}Mg_{z2}, wherein z1+z2=0.1, wherein synthesis occurs using a sintering temperature of 1000° C.

FIG. 6C provides an expanded diagram for Na_{0.85}Mn_{0.5}Ni_{0.2}Fe_{0.1}φ_{z}O₂ wherein φ_{z} is more specifically Mg_{z1}Cu_{z2}Ti_{z3}, wherein z1+z2+z3=0.2, wherein synthesis occurs using a sintering temperature of 1000° C., and wherein the horizontal axes represent z2 and z1 while the vertical axis represents z3.

FIG. 7A provides cycling performance (cycling stability) plots of specific capacity for six different layered oxide cathode materials of a fourth groups of cathode materials sintered at a temperature of 900° C. with each having a composition of A_{w}NaᵤMn_{0.5}NiᵥFe_{0.1}φ_{z}O₂ wherein A is a placeholder for Li while w indicates the amount of Li, u indicates the amount of sodium, v represents the amount of nickel, and φ_{z} represents Mg_{z1}Cu_{z2} or just Cu_{z} with the amounts of each material shown in the formulas of FIG. 7A.

FIG. 7B provides voltage profile plots for the layered oxide cathodes of FIG. 7A during charging and discharging such that voltage changes and particularly voltage steps (or lack of steps) associated with the different cathode materials can be seen.

FIG. 7C provides Cu Kα powder X-ray diffractogram (XRD) plots for the layered oxide cathodes of FIGS. 7A and 7B.

FIG. 8A provides cycling performance (cycling stability) plots of specific capacity for five different layered oxide cathode materials sintered at a temperature of 900° C. with each measured over a 2.0-4.2 V vs. Na⁺/Na voltage window with each having a composition of Na_{0.85}Mn_{0.5}NiᵥFe_{0.1}φ_{z}O₂, wherein v represents the amount of nickel which ranges from a 0.2 to 0.4 molar fraction, Oz represents Cu_{z1}Mg_{z2}Ti_{z3} with the amounts of each material shown in the formulas of FIG. 8A.

FIG. 8B provides 5th cycle voltage profile plots for the five layered oxide cathodes of FIG. 8A during charging and discharging measured over a 2-4.2 V vs. Na⁺/Na voltage window such that voltage changes and particularly voltage steps (or lack of steps) associated with the different cathode materials can be seen after 5 cycles.

FIG. 8C provides 100th cycle voltage profile plots for the five layered oxide cathodes of FIG. 8A during charging and discharging measured over a 2-4.2 V vs. Na⁺/Na voltage window such that voltage changes and particularly voltage steps (or lack of steps) associated with the different cathode materials can be seen after 100 cycles.

FIGS. 9A and 9B provide in situ XRD contour plots along with corresponding electrochemical performance plots for MNF and MNFCM respectively.

FIGS. 9C and 9D provide ex situ XRD contour plots of MNF and MNFCM, respectively at different states of charge during charging to 4.0 V with the panels on the right of each showing the corresponding magnified (001) region.

FIGS. 10A, 10B, and 10C respectively provide ex situ XRD plots of MNF, MNFCM, and MNFCMT at different states of charge with FIG. 10C also providing a magnified view of the (001) region.

FIGS. 11A, 11B, and 11C respectively provide XRD plots of MNF, MNFCM, and NMFCMT to the left and offset voltage profiles to the right when cycled between 2.0 and 4.2 V and stopped at either the charged state (4.2 V) or discharged state (2.0 V) after various cycles.

### DETAILED DESCRIPTION OF THE INVENTION

Various advantages and novel features of the present invention are described herein and will become further apparent to those skilled in this art from the following detailed description. In the preceding and following descriptions the preferred embodiment of the invention is shown by way of illustration of the best mode contemplated for carrying out the invention along with a number of variations. As will be realized, embodiments of the invention are capable of modification in various respects without departing from the spirit of the invention as will be understood by those of skill in the art.

A series of cathode materials were synthesized to investigate improving electrochemical performance and reducing the cost of sodium-ion batteries (SIBs). These investigations involved partially substituting Ni with selected dopants. Reducing the Ni content lowers material cost, while the selected dopants enhance electrochemical performance by mitigating phase transitions during sodium extraction.

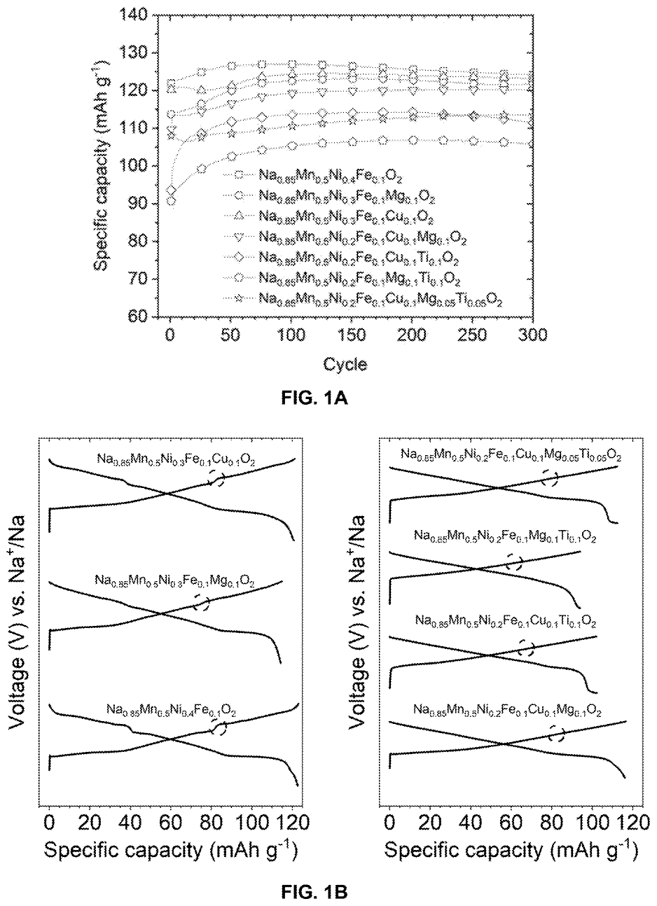

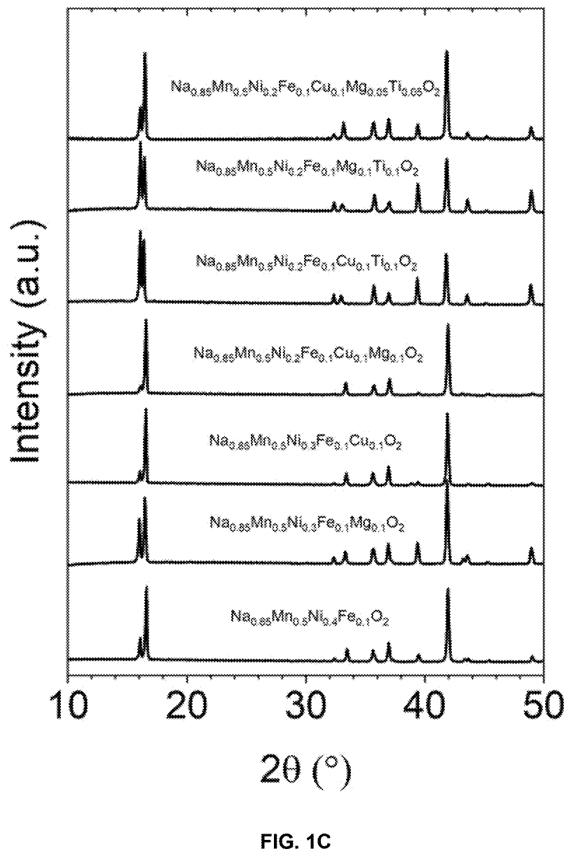

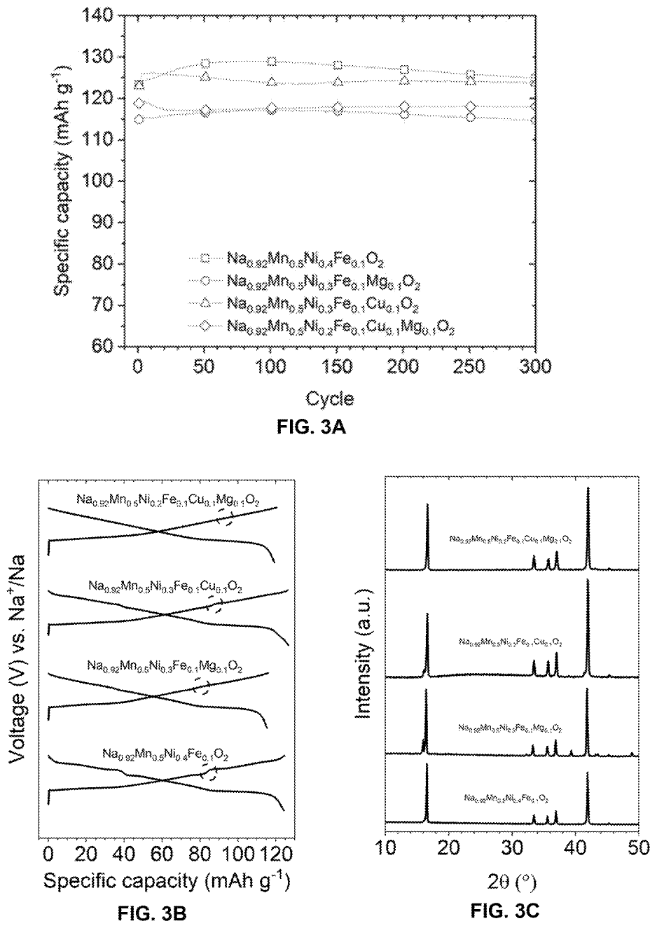

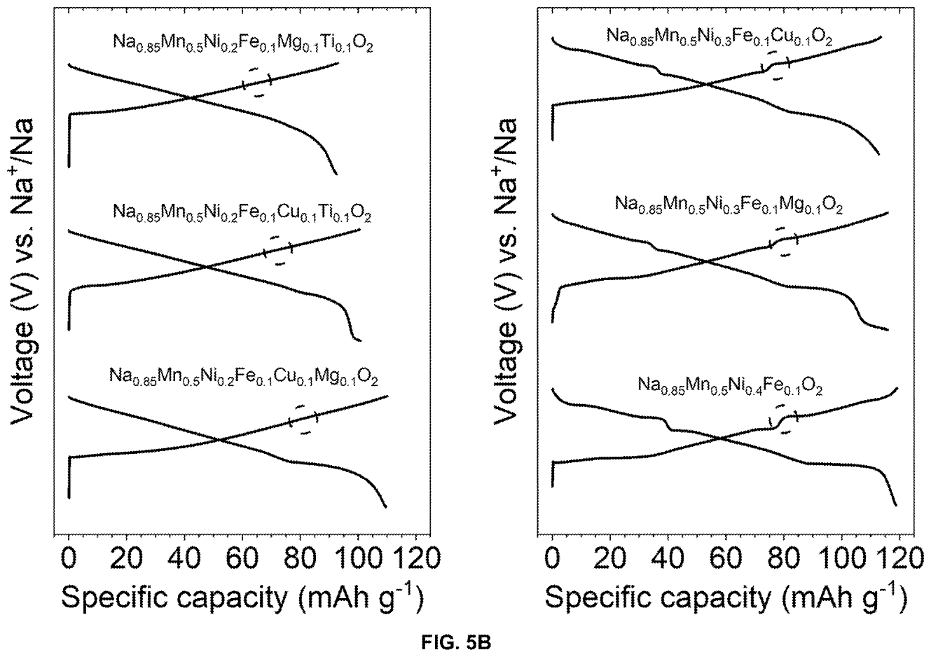

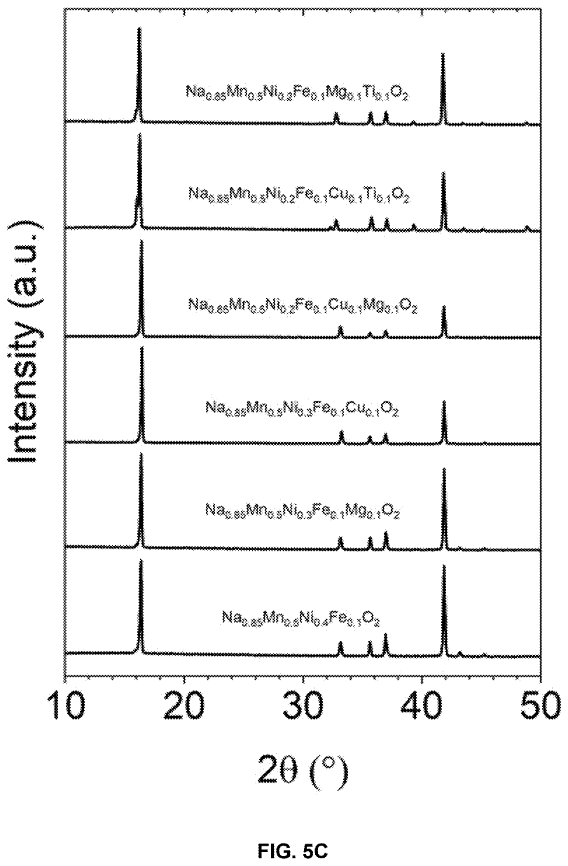

In FIG. 1A, the sodium content is fixed at a 0.85 molar fraction, and the cathodes were synthesized at 900° C. In FIG. 3A, the sodium content is increased to a 0.92 molar fraction with the same synthesis temperature of 900° C. In FIG. 5A, the sodium content is again fixed at a 0.85 molar fraction, but the synthesis temperature is raised to 1000° C. Across these datasets, the Ni content is systematically reduced from 40% in the baseline composition to 20% through substitution with other dopants.

Hereafter several tables are provided that provide electrochemical performance data showing that most substituted samples exhibit improved cycling stability compared to their respective baseline materials over the same number of cycles. This is especially highlighted in the high voltage data where the baseline material degrades much more rapidly than doped samples.

Hereafter, some figures provide 5th cycle voltage profiles of selected layered oxide cathodes. In these figures, a baseline material exhibits distinct voltage steps, indicative of phase transitions during cycling. Introduction of a single dopant tends to smooth the voltage profile. For example, an Mg doped cathode displays a more gradual profile compared to Cu doped, demonstrating that dopant identity influences the extent of step suppression.

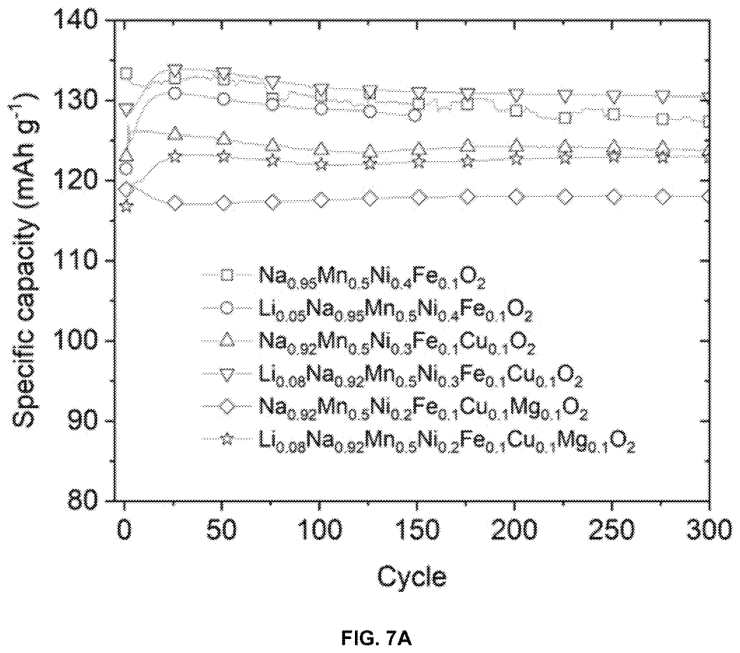

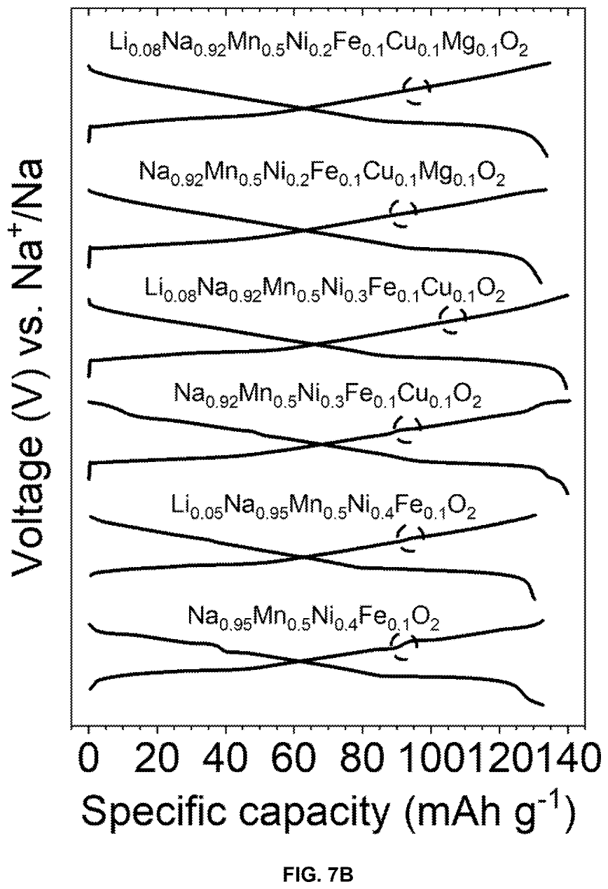

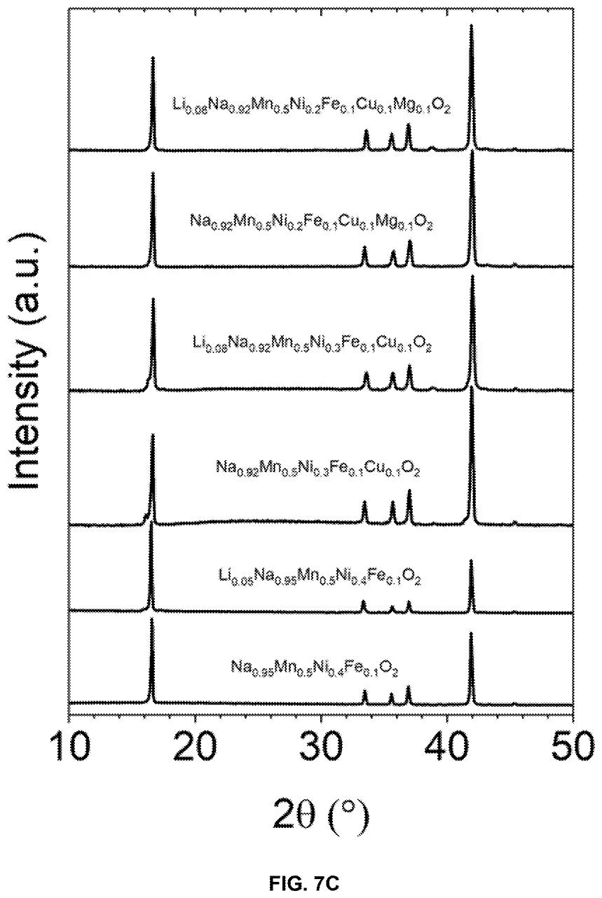

The number of dopants tends to have an even more pronounced effect on profile smoothness. Samples containing two or more dopants effectively eliminate the voltage step at ~3.5 V vs. Na⁺/Na. Both the atomic characteristics and the number of dopants tend to play significant roles in governing the electrochemical behavior of layered oxide cathodes, impacting reversible capacity, average operating voltage, and long-term cycling stability. For example, as discussed further below, in FIG. 7B, the effect of step smoothening can be clearly seen when comparing Na_{0.92}Mn_{0.5}Ni_{0.3}Fe_{0.1}Cu_{0.1}O₂ & Li_{0.08}Na_{0.92}Mn_{0.5}Ni_{0.3}Fe_{0.1}Cu_{0.1}O₂. Again, this shows that the number of dopants has a big effect on step suppression. However, for highly doped samples Na_{0.92}Mn_{0.5}Ni_{0.2}Fe_{0.1}Cu_{0.1}Mg_{0.1}O₂ and Li_{0.08}Na_{0.92}Mn_{0.5}Ni_{0.2}Fe_{0.1}Cu_{0.1}Mg_{0.1}O₂, the smoothening affect is not as obvious, but the increase in reversible capacity is noticeable in the cycling data.

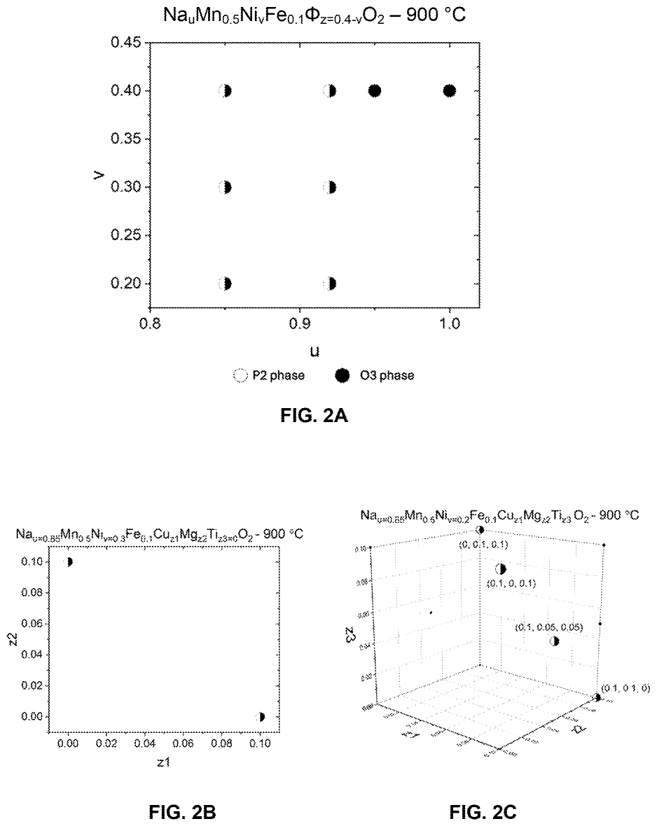

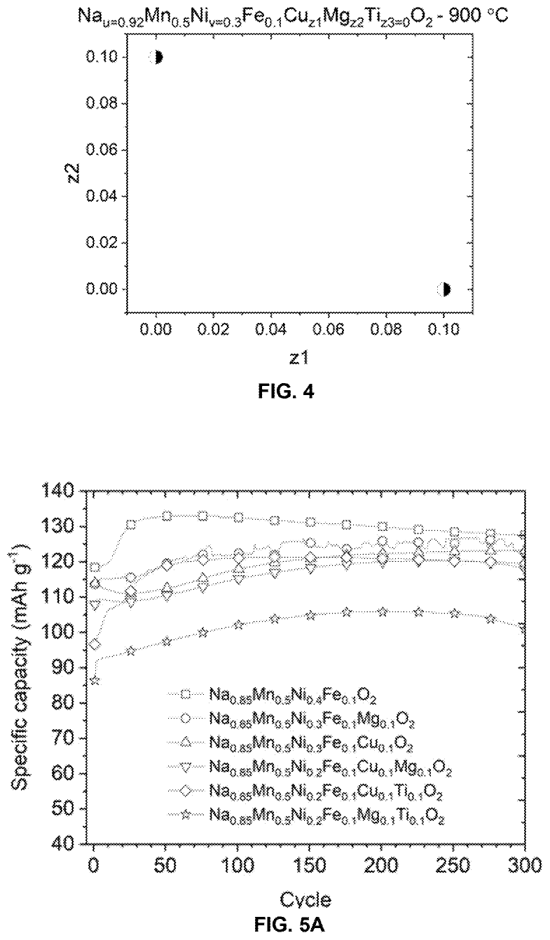

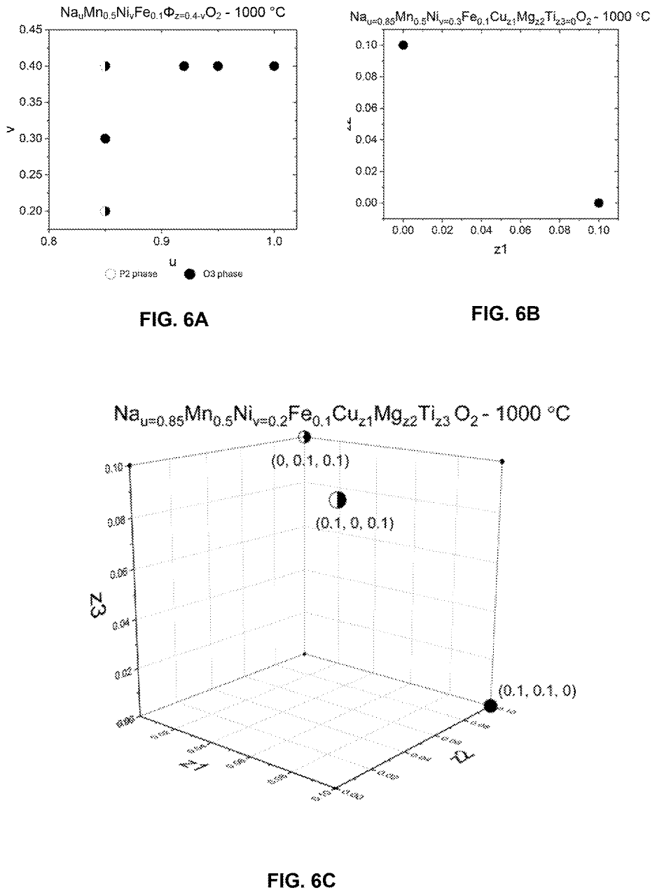

Synthesis phase diagrams were constructed for cathodes with Na content at 0.85 and 0.92 molar fractions when prepared at 900° C., and Na content at a 0.85 molar fraction when prepared (i.e. sintered) at 1000° C. General phase diagrams for cathodes with the formula NaᵤMn_{0.5}NiᵥFe_{0.1}φ_{0.4-v}O₂ are shown FIGS. 2A, 4A and 6A based on synthesis temperatures of 900° C., 900° C., and 1000° C. respectively. The parameters u and v denote the Na and Ni content, respectively, and the explored compositions are indicated by circles within the diagram. A black filled circle denotes the presence of a layered O3 phase, whereas a white semicircle indicates the presence of a P2 phase. The filled or unfilled portions of the symbols do not represent phase fractions; rather, they simply indicate the presence of the O3 or P2 phase. The actual phase proportions may vary widely depending on u, v, and the dopants (φ or A). Subsets of the general phase diagrams are seen FIGS. 2B, 4B, 6B respectively. The phase diagram for FIGS. 2B and 6B fixes u, v, and z3 to 0.85, 0.3, and 0 respectively, while that for FIG. 4B fixes u, v, and z3 to 0.92, 0.3, and 0 respectively. Further subsets of the general phase diagrams are seen FIGS. 2C and 6C which fix u, and v (u=0.85, v=0.2) and sintering temperature of 900° C. and 1000° C., respectively. These diagrams serve to visually show which phases are present based on temperature and component presence and quantity.

### Cathode Material Synthesis Using Metal Hydroxide Precursors & Coprecipitation

Metal hydroxide precursors, TM(OH)₂ and TM (e.g. Mn, Ni, Al, etc.) are prepared by a co-precipitation process. As used above TM refers to transition metals while TM(OH)₂ refers to transition metal hydroxides. For the synthesis of baseline cathode, Na_{0.85}Mn_{0.5}Ni_{0.4}Fe_{0.1}O₂, Mn_{0.5}Ni_{0.4}Fe_{0.1}(OH)₂ is synthesized using an aqueous solution containing Mn, Ni, and Fe salts. For multielement-doped cathodes, aqueous solutions containing Mn, Ni, Fe, together with Cu, Mg, Ti, or other metal salts, are used. These metal salt solutions were continuously pumped into a reactor together with NaOH and NH₄OH solutions under a nitrogen atmosphere. The reaction was conducted at 50-60° C. with stirring at 900-1000 rpm, while the pH was maintained at 10.5-11.0. Once steady-state operation was achieved, the precipitates were collected, aged, filtered, washed with deionized water, and dried overnight to obtain the hydroxide precursors. The precursors were then thoroughly mixed with NaOH or Na₂CO₃ and calcined at selected temperatures to obtain spherical NaₓTMO₂.

### Cathode Material Synthesis Using Solid State Synthesis:

Alkali carbonate (LiOH, NaOH, Na₂CO₃·H₂O, etc.) and Metal oxide (e.g., Mn₂O₃, NiO, Fe₂O₃) are mixed in an isopropanol medium and homogenized using a planetary ball milling at 500 rpm for 7 h. For doped compositions, additional precursors—including oxides (e.g., MgO, CuO, TiO₂) and hydroxides (e.g., LiOH, KOH)—are incorporated during this initial mixing step as dopant sources. The resulting slurry is dried to remove the alcohol medium. Once dried, the powders are ground and subjected to a two-step thermal treatment. First, the powders are heated to 550° C. at a ramp rate of 5° C. min-1 and held for 5 h. The temperature is then increased to the desired final temperature (e.g., 900 or 1000° C.) at the same ramp rate and maintained for 14 h. Finally, the furnace is cooled to room temperature at a rate of 5° C. min-1.

Furthermore, dopants can be introduced through an additional heating step. After the initial synthesis, dopants sources such as alkali compounds (e.g., LiOH, KOH, etc.) can be homogenously mixed with a synthesized cathode and reheated in furnace to achieve doping.

Overall, cathode synthesis is achieved by thoroughly mixing stoichiometric amounts of alkali carbonates (e.g., Na₂CO₃·H₂O, Li₂CO₃) with metal oxides or metal hydroxide precursors and heating to achieve the final product.

Preparation of Electrode from Synthesized Cathode

Electrodes were fabricated by combining the synthesized cathode material with conductive carbon and a polymeric binder solution in controlled proportions to achieve the desired composition. The mixture was homogenized using a planetary mixer to produce a uniform slurry. This slurry was then cast onto foil using a film applicator, with the target active material loading controlled by adjusting the applicator gap during coating. The coated electrodes were subsequently dried in a dynamic vacuum oven to remove residual solvent and yield the final electrode films.

### Sodium-Ion Batteries:

A sodium-ion battery (SIB) is a rechargeable (secondary) battery that uses sodium ions (Na⁺) to store and transfer energy. During charging, Na⁺ ions move from the cathode to the anode, and during discharge they migrate back from anode to the cathode, releasing electrical energy which can be used to power devices.

The main components of an SIB include a positive electrode (cathode), typically composed of layered metal oxides; a negative electrode (anode), that is most commonly made of hard carbon, but can also be soft carbon, or be of the sodium alloy type (e.g. including Tin (Sn), Phosphorus (P), Antimony (Sb), Lead (Pb), Bismuth (Bi), and the like); and an electrolyte, usually a liquid that enables the transport of sodium ions between the electrodes. Sodium-ion electrolytes typically consist of common salts such as NaPF₆, NaClO₄, NaFSI, and NaTFSI dissolved in mixtures of carbonate-based solvents, including ethylene carbonate (EC), propylene carbonate (PC), diethyl carbonate (DEC), dimethyl carbonate (DMC), and ethyl methyl carbonate (EMC). An example of a representative formulation is 1 M NaPF₆ in EC:PC:DMC (1:1:1). These salts can also be paired with ether-based solvents, such as dimethoxyethane (DME) and glymes (e.g., diglyme (G2), triglyme (G3), and tetraglyme (G4)). For example, 1M NaPF₆ in DME is a commonly studied ether-based system. In addition, high-concentration electrolytes (HCEs) such as 3 M NaFSI in DME can be used. Localized high-concentration electrolytes (LHCEs) further incorporate inert diluents such as 1,1,2,2-tetrafluoroethyl 2,2,3,3-tetrafluoropropyl ether (TTE) and Bis(2,2,2-trifluoroethyl) ether (BTFE) to reduce the overall concentration of HCEs; an example is 1 M NaFSI in DME/BTFE, which maintains the beneficial solvation structure of HCEs while reducing viscosity.

A separator is placed between the electrodes to prevent physical contact between electrodes while still allowing ionic movement necessary for proper battery operation. Separators are typically made from Polyolefin materials such as Polypropylene (PP), polyethylene (PE), or multilayer combinations (e.g., PP/PE/PP). Additionally, the former can be ceramic coated (e.g., Al₂O₃, SiO₂) to improve performance.

Sodium is an abundant and widely available resource, which makes sodium-ion batteries potentially low cost. As a result, they are particularly attractive for applications such as grid-scale energy storage, low-cost electric vehicles, and backup power systems.

### O3 and P2 Phases of Layered Sodium Cathode Materials:

Layered sodium cathode materials (A_{w}NaᵤMnₓNiᵥFe_{y}φ_{z}O₂) can adopt structural types categorized as O3 and P2. The designations such as “O3” and “P2” refer to the specific stacking sequences of the transition metal oxide layers and the sodium-ion coordination environments. “O” in O3 indicates that the sodium ions occupy octahedral sites between the transition metal oxide layers. The “3” in O3 refers to the number of transition metal oxide layers within the unit cell with a stacking sequence (ABCABC). Similarly, “P” in P2 indicates that the sodium ions occupy prismatic sites between the transition metal oxide layers. The “2” in P2 refers to the number of transition metal oxide layers within the unit cell with a stacking sequence (ABBA). Elements designated using “A_{w}” reside between transition metal oxide layers, while elements specified by “z” reside within transition metal oxide layers.

### EXAMPLES

Layered sodium-ion oxides with a chemical formula of Li_{w}NaᵤMnₓNiᵥFe_{y}φ_{z}O₂ or more specifically Li_{w}NaᵤMnₓNiᵥFe_{y}Mg_{z1}Cu_{z2}Ti_{z3}O₂ were studied with 0<=w<=0.4; 0.6<=u<=1.0; 0.2<=x<=1; 0<=v<=0.4; 0<=y<=0.4; and 0<=z=z1+z2+z3<=0.4.

### Example Group 1

Synthesized layered oxide cathodes were made into electrodes and electrochemically cycled in a half cell configuration with Sodium metal (Na) as the counter electrode. The cells were cycled from 2-4 V vs. Na⁺/Na for 300 cycles. All samples exhibited excellent cycling stability with little capacity fading within the 300 cycles. The Ni content was reduced from 40% in the baseline material (Na_{0.85}Mn_{0.5}Ni_{0.4}Fe_{0.1}O₂) to as low 20% in 4 of the cathode formulations. The sample with the best capacity retention was Na_{0.85}Mn_{0.5}Ni_{0.2}Fe_{0.1}Cu_{0.1}Mg_{0.1}O₂. Formulas are also set forth in Table 1 along with some electrochemical data. The baseline material achieved a capacity retention of ~97% after 300 cycles with the rest of the samples reaching ≥97% (See Table 1). Reducing the Ni content while achieving similar reversable capacity can reduce material cost while retaining excellent cycling stability.

TABLE 1
Group 1 Cathode Materials and Electrochemical Results

| | | Final | |
|---|---|---|---|
| | Max | capacity | |
| | Capac- | (@300 | Capacity |
| Sample name | ity | cycles) | Retention |
| Na_{0.85}Mn_{0.5}Ni_{0.4}Fe_{0.1}O₂ | 127 | 124.1 | 97.72 |
| Na_{0.85}Mn_{0.5}Ni_{0.3}Fe_{0.1}Mg_{0.1}O₂ | 123.1 | 121.7 | 98.86 |
| Na_{0.85}Mn_{0.5}Ni_{0.3}Fe_{0.1}Cu_{0.1}O₂ | 124.4 | 123.1 | 98.95 |
| Na_{0.85}Mn_{0.5}Ni_{0.2}Fe_{0.1}Cu_{0.1}Mg_{0.1}O₂ | 120.3 | 120.3 | 100.00 |
| Na_{0.85}Mn_{0.5}Ni_{0.2}Fe_{0.1}Cu_{0.1}Ti_{0.1}O₂ | 114.2 | 111.4 | 97.55 |
| Na_{0.85}Mn_{0.5}Ni_{0.2}Fe_{0.1}Mg_{0.1}Ti_{0.1}O₂ | 106.4 | 105.8 | 99.44 |
| Na_{0.85}Mn_{0.5}Ni_{0.2}Fe_{0.1}Cu_{0.1}Mg_{0.05}Ti_{0.05}O₂ | 113.6 | 113.5 | 99.91 |

FIG. 1A provides cycling performance (cycling stability) plots for seven different layered oxide cathode materials synthesized at 900° C. with a 0.85 Na molar fraction measured over a 2-4 V vs. Na⁺/Na voltage window having compositions of NaᵤMnₓNiᵥFe_{y}φ_{z}O₂ and more specifically to Na_{u=0.85}Mn_{x=0.5}NiᵥFe_{y=0.1}φ_{z}O₂ where φ_{z} represents zero to three elements with each present in an amount that is specific to it for each variation wherein φ_{z} can be more specifically represented as Mg_{z1}Cu_{z2}Ti_{z3} wherein 0<=z1<=0.1, 0<=z2<=0.1, 0<=z3<=0.1. The values of the various subscripts are shown in FIG. 1A for each of the seven materials shown. In other embodiments, alternative dopants or groups of dopants may be used, in similar or different numbers, or in similar or different amounts.

FIG. 1B, divided into two separate plots, provides 5th cycle voltage profiles of the layered cathodes of FIG. 1A measured over a 2-4 V vs. Na⁺/Na voltage window such that voltage changes and particularly voltage steps (or lack of steps) associated with the different cathode materials can be seen.

The baseline material (Na_{0.85}Mn_{0.5}Ni_{0.4}Fe_{0.1}O₂) clearly shows the distinct steps in the voltage profile. A single dopant has the effect of reducing the steps, with Mg doped cathode having a smoother profile compared to Cu, demonstrating that the type of dopant plays a role in evening out the steps in the profile. The number of dopants has a greater effect on the smoothness of the voltage profile. Samples with two or more dopants eliminate the voltage step at 3.5 V vs. Na⁺/Na and produce a smooth voltage profile as shown by the dashed circles shown in FIG. 1B as well as in FIGS. 3B, 5B, and 7B. The atomic number and number of dopants both play a role in the electrochemistry of the layered oxide cathode. Affecting reversible capacity, average voltage and long-term stability.

FIG. 1C provides Cu Kα Powder X-ray diffractogram (XRD) patterns for the layered oxide cathodes of FIGS. 1A and 1B.

After synthesis, the cathode materials were crushed into a fine powder and diffraction measurements were carried out using a Malvern Panalytical Empyrean X-ray diffractometer. In FIG. 1C, cathode formulations with the same sodium content but varying amounts of dopants were synthesized at 900° C. All samples reveal representative peaks of layered O3 and P2 phases with no impurity phases present. Although synthesized at the same temperature, the identity and number of dopants determine the proportion of O3 or P2.

FIG. 2A provides a synthesis phase diagram of NaᵤMn_{0.5}NiᵥFe_{0.1}φ_{z=0.4-v}O₂ wherein φ_{z} is Mg_{z1}Cu_{z2}Ti_{z3}, wherein 0<=z<0.2, and z=z1+z2+z3=0.4−v, wherein the sintering temperature was 900° C. and wherein the vertical axis shows data from for v from 0.2 to 0.4 and the horizontal axis shows data for u from 0.85 to 1.0.

The parameters u and v denote the Na and Ni content, respectively, and the explored compositions are indicated by circles within the diagram. A black filled circle denotes the presence of a layered O3 phase, whereas a white semicircle indicates the presence of a P2 phase. The filled or unfilled portions of the symbols do not represent phase fractions; rather, they simply indicate the presence of the O3 or P2 phase. The actual phase proportions may vary widely depending on u, v, and the dopants (φ).

FIG. 2B provides an expanded diagram for Na_{0.85}Mn_{0.5}Ni_{v=0.3}Fe_{0.1}φ_{z}O₂ wherein φ_{z} is more specifically Mg_{z1}Cu_{z2}Ti_{z3=0} or more simply Mg_{z1}Cu_{z2} with synthesis occurring using a sintering temperature of 900° C., the vertical axis represents z2 while the horizontal axis represents z1, and wherein z=z1+z2=0.1. At these conditions the cathodes favor a mixed phase between P2 and O3. This graph is meant to visually demonstrate the phases present in the synthesized materials.

FIG. 2C provides an expanded diagram for Na_{0.85}Mn_{0.5}Ni_{v=0.2}Fe_{0.1}φ_{z}O₂ wherein φ_{z} is more specifically Mg_{z1}Cu_{z2}Ti_{z3} with synthesis occurring based on a sintering temperature of 900° C., wherein the horizontal axes represent z2 and z1 while the vertical axis represents z3, and wherein z=z1+z2+z3=0.2. To aid in visualization, small black dots are provided and represent projections of the 3D points on each plane. At these conditions the cathodes favor a mixed phase between P2 and O3. This graph is meant to visually demonstrate the phases present in the synthesized materials.

### Example Group 2

FIG. 3A provides cycling performance (cycling stability) plots for a second group of cathode materials. Four different layered oxide cathode materials are included in this group with the cathodes being synthesized at 900° C. with a 0.92 Na molar fraction measured over a 2-4 volt vs. Na⁺/Na voltage window with each having a composition of Na_{0.92}Mn_{0.5}NiᵥFe_{0.12}O₂ wherein φ_{z} represents dopant elements and amounts ranging from zero elements to two elements with each dopant that is present having a molar fraction amount of 0.1 that is different for each composition wherein φ_{z} can be more specifically represented as Mg_{z1}Cu_{z2} or Cu_{z1}Mg_{z2} wherein 0<=z1<=0.1 and 0<=z2<=0.1 with one of the four materials being a baseline material without additives (z1=0 and z2=0) and the other three materials include one or both additives (i.e., Mg and/or Cu) in the relative amounts shown in the formulas. Formulas are also set forth in Table 2 along with some electrochemical data. In other embodiments, alternative dopants or groups of dopants may be used, in similar or different numbers, or in similar or different amounts.

Synthesized layered oxide cathodes were made into electrodes and electrochemically cycled in a half cell configuration with Sodium metal (Na) as the counter electrode. The cells were cycled from 2-4 V vs. Na⁺/Na for 300 cycles. All samples exhibited excellent cycling stability with little capacity fading within the 300 cycles. The Ni content was reduced from 40% in the baseline material to as low 20% in one of the cathode formulations. The top performing sample with Ni content of 0.2 was Na_{0.92}Mn_{0.5}Ni_{0.2}Fe_{0.1}Cu_{0.1}Mg_{0.1}O₂ which provided a capacity retention of 98.8% after 300 cycles. The baseline material achieved a capacity retention of ~97% after 300 cycles with the rest of the samples reaching ≥97% (see Table 2). Reducing the Ni content while achieving similar reversable capacity may reduce material cost while retaining excellent cycling stability.

TABLE 2
Group 2 Cathode Materials and Electrochemical Results

| | | Final | |
|---|---|---|---|
| | Max | capacity | |
| | Capac- | (@300 | Capacity |
| Sample name | ity | cycles) | Retention |
| Na_{0.92}Mn_{0.5}Ni_{0.4}Fe_{0.1}O₂ | 129 | 124.9 | 96.8 |
| Na_{0.92}Mn_{0.5}Ni_{0.3}Fe_{0.1}Mg_{0.1}O₂ | 117 | 114.7 | 97.9 |
| Na_{0.92}Mn_{0.5}Ni_{0.3}Fe_{0.1}Cu_{0.1}O₂ | 126.1 | 123.8 | 98.2 |
| Na_{0.92}Mn_{0.5}Ni_{0.2}Fe_{0.1}Cu_{0.1}Mg_{0.1}O₂ | 119.4 | 118 | 98.8 |

FIG. 3B provides 5th cycle voltage profiles of the layered oxide cathodes of FIG. 3A measured over a 2-4 V vs. Na⁺/Na voltage window during charging and discharging such that voltage changes and particularly voltage steps (or lack of steps) associated with the different cathode materials can be seen.

The baseline material (Na_{0.92}Mn_{0.5}Ni_{0.4}Fe_{0.1}O₂) clearly shows the distinct steps in the voltage profile. A single dopant has the effect of reducing the steps, with Mg doped cathode having a smoother profile compared to Cu, demonstrating that identity of dopant plays a role in evening out the steps in the profile. The number of dopants also has a greater effect on the smoothness of the voltage profile. Samples with two or more dopants eliminate the voltage step at 3.5 V vs. Na⁺/Na and produce a smooth voltage profile. The atomic number and number of dopants both play a significant role in the electrochemistry of the layered oxide cathode. Affecting reversible capacity, average voltage and long-term stability.

FIG. 3C provides Cu Kα powder X-ray diffractogram (XRD) patterns for the layered oxide cathodes of FIGS. 3A and 3B.

After synthesis, the cathode materials were crushed into a fine powder and diffraction measurements were carried out using a Malvern Panalytical Empyrean X-ray diffractometer. All samples are either O3 and or mixed phase with P2 phases with no impurity signs of significant impurity phases present. Although synthesized at the same temperature, the identity and number of dopants determine the proportion of O3 or P2. Na_{0.92}Mn_{0.5}Ni_{0.4}Fe_{0.1}O₂ and Na_{0.92}Mn_{0.5}Ni_{0.2}Fe_{0.1}Cu_{0.1}Mg_{0.1}O₂ are majorly in O3 phase with minimal sign of P2 phase while Na_{0.92}Mn_{0.5}Ni_{0.3}Fe_{0.1}Mg_{0.1}O₂ and Na_{0.92}Mn_{0.5}Ni_{0.3}Fe_{0.1}Cu_{0.1}O₂ show distinct peaks indicating presence of O3 and P2.

FIG. 4 provides a diagram for Na_{0.92}Mn_{0.5}Ni_{v=0.3}Fe_{0.1}φ_{z}O₂ wherein φ_{z} is more specifically Cu_{z1}Mg_{z1}Ti_{z3=0} or more simply Cu_{z1}Mg_{z2}, wherein z1+z2=0.1, wherein synthesis occurs using a sintering temperature of 900° C., and wherein the vertical axis represents z2 from 0.00 to 0.10 while the horizontal axis represents z1 from 0.00 to 0.10. At these conditions the cathodes favor a mixed phase between P2 and O3. This graph is meant to visually demonstrate the phases present in the synthesized materials.

### Example Group 3

FIG. 5A provides cycling performance (cycling stability) plots of specific capacity for six different layered oxide cathode materials of a third group of cathode materials synthesized at 1000° C. with a 0.85 Na molar fraction measured over a 2-4 V vs. Na⁺/Na voltage window with each having a composition of Na_{0.85}Mn_{0.5}NiᵥFe_{0.1}φ_{z}O₂ wherein φ_{z} represents zero to two dopant elements selected from the group of Mg, Cu, and Ti with each present in an molar fraction amount, for each of the six materials, corresponding to values shown in the formulas of FIG. 5A in the form of Mg_{z1}Cu_{z2}Ti_{z3} where 0<=z1<=0.1, 0<=z2<=0.1, 0<=z3<=0.1, where z1+z2+z3=0.4−v. Formulas are also set forth in Table 3 along with some electrochemical data. In other embodiments, alternative dopants or groups of dopants may be used, in similar or different numbers, or in similar or different amounts.

In this group, synthesized layered oxide cathodes were made into electrodes and electrochemically cycled in half cell configurations with Sodium metal (Na) as the counter electrode. The cells were cycled from 2-4 V vs. Na⁺/Na for 300 cycles. All samples exhibited excellent cycling stability with little capacity fading within the 300 cycles. The Ni content was reduced from a 0.4 molar fraction in the baseline material to as low as 0.2 molar fraction in one of the cathode formulations. The top performing sample with a Ni content of 0.3 molar fraction was Na_{0.92}Mn_{0.5}Ni_{0.3}Fe_{0.1}Cu_{0.1}O₂ with capacity retention of no capacity fade after 300 cycles. The baseline material achieved a capacity retention of ~93% after 300 cycles with the rest of the samples reaching >95% (see Table 3). Reducing the Ni content while achieving similar reversable capacity may reduce material cost while retaining excellent cycling stability.

TABLE 3
Group 3 Cathode Materials and Electrochemical Results

| | | Final | |
|---|---|---|---|
| | Max | capacity | |
| | Capac- | (@300 | Capacity |
| Sample name | ity | cycles) | Retention |
| Na_{0.85}Mn_{0.5}Ni_{0.4}Fe_{0.1}O₂ | 132.9 | 127.6 | 93.3 |
| Na_{0.85}Mn_{0.5}Ni_{0.3}Fe_{0.1}Mg_{0.1}O₂ | 126.7 | 122.7 | 96.7 |
| Na_{0.85}Mn_{0.5}Ni_{0.3}Fe_{0.1}Cu_{0.1}O₂ | 123 | 123.2 | 100 |
| Na_{0.85}Mn_{0.5}Ni_{0.2}Fe_{0.1}Cu_{0.1}Mg_{0.1}O₂ | 120.3 | 117.9 | 98.0 |
| Na_{0.85}Mn_{0.5}Ni_{0.2}Fe_{0.1}Cu_{0.1}Ti_{0.1}O₂ | 121.3 | 119.5 | 98.5 |
| Na_{0.85}Mn_{0.5}Ni_{0.2}Fe_{0.1}Mg_{0.1}Ti_{0.1}O₂ | 105.9 | 100.9 | 95.5 |

FIG. 5B provides 5th cycle voltage profiles of the layered oxide cathodes of FIG. 5A measured over a 2-4 V vs. Na⁺/Na voltage window versus specific capacity during charging and discharging such that voltage changes and particularly voltage steps (or lack of steps) associated with the different cathode materials can be seen.

The baseline material (Na_{0.85}Mn_{0.5}Ni_{0.4}Fe_{0.1}O₂) clearly shows the distinct steps in the voltage profile. A single dopant has the effect of reducing the steps, with Mg doped cathode having a smoother profile compared to Cu, demonstrating that the type of dopant plays a role in evening out the steps in the profile. The number of dopants also has an effect on the smoothness of the voltage profile. Samples with two or more dopants eliminate the voltage step at 3.5 V vs. Na⁺/Na and produce a smooth voltage profile. The atomic number and number of dopants both play a role in the electrochemistry of the layered oxide cathode. Affecting reversible capacity, average voltage and long-term stability.

FIG. 5C provides Cu Kα powder X-ray diffractogram XRD patterns for the layered oxide cathodes of FIGS. 5A and 5B.

After synthesis, the cathode materials were crushed into a fine powder and diffraction measurements were carried out using a Malvern Panalytical Empyrean X-ray diffractometer. In FIG. 5C, cathode formulations with the same sodium content but varying amounts of dopants were synthesized at 1000° C. All samples are either O3 and or mixed phase with P2 phases with no signs of significant impurity phases present. Although synthesized at the same temperature, the identity and number of dopants determine the proportion of O3 or P2. As the temperature increases to 1000° C., the P2 phase becomes less significant, and the dominant phase becomes O3. At this temperature the only samples showing appreciable amounts of P2 are Na_{0.85}Mn_{0.5}Ni_{0.2}Fe_{0.1}Cu_{0.1}Ti_{0.1}O₂ and Na_{0.85}Mn_{0.5}Ni_{0.2}Fe_{0.1}Mg_{0.1}Ti_{0.1}O₂.

FIG. 6A provides a synthesis phase diagram for cathodes with the general formula of NaᵤMn_{0.5}NiᵥFe_{0.1}φ_{z}O₂ sintered at 1000° C., wherein φ represents possible dopants and z represents a sum of the quantities of such dopants expressed as molar fractions. The plot shows v ranging from 0.2 to 0.4 which corresponds to z ranging from 0.2 to 0.

The parameters u and v denote the Na and Ni content, respectively, and the explored compositions are indicated by circles within the diagram. A black filled circle denotes the presence of a layered O3 phase, whereas a white semicircle indicates the presence of a P2 phase. The filled or unfilled portions of the symbols do not represent phase fractions; rather, they simply indicate the presence of the O3 or P2 phase. The actual phase proportions may vary widely depending on u, v, and the dopants (φ). At this temperature, even though a mixture of P2 and O3 is present, O3 is dominant.

FIG. 6B provides an expanded diagram for Na_{0.85}Mn_{0.5}Ni_{0.3}Fe_{0.1}φ_{z}O₂, wherein φ_{z} is more specifically Cu_{z1}Mg_{z2}, wherein z=z1+z2=0.1, wherein synthesis occurs using a sintering temperature of 1000° C., and wherein the vertical axis represents z2 while the horizontal represents z1. At these conditions the cathodes favor an O3 dominant phase. This graph is meant to visually demonstrate the phases present in the synthesized materials.

FIG. 6C provides an expanded diagram for Na_{0.85}Mn_{0.5}Ni_{0.2}Fe_{0.1}φ_{z}O₂ wherein φ_{z} is more specifically Mg_{z1}Cu_{z2}Ti_{z3}, wherein z1+z2+z3=0.2, wherein synthesis occurs using a sintering temperature of 1000° C., and wherein the horizontal axes represent z2 and z1 while the vertical axis represents z3. To aid in visualization, small black dots are provided and represent projections of the 3D points on each plane. At these conditions the cathodes mostly favor a mixed phase between P2 and O3, but one composition is O3 dominant. This graph is meant to visually demonstrate the phases present in the synthesized materials.

### Example Group 4

FIG. 7A provides cycling performance (cycling stability) plots of specific capacity for six different layered oxide cathode materials of a fourth group of cathode materials sintered at a temperature of 900° C. with each measured over a 2-4 V vs. Na⁺/Na voltage window with each having a composition of A_{w}Naᵤ Mn_{0.5}NiᵥFe_{0.1}φ_{z}O₂ wherein A is a placeholder for Li while w indicates the amount of Li which is either 0, 0.05, or 0.08 molar fraction in the cathode materials, u indicates the amount of sodium which is either 0.92 or 0.95 molar fraction in the cathode materials, v represents the amount of nickel which ranges from 0.2 to 0.4 molar fraction in the cathode materials, and φ_{z} represents Mg_{z1}Cu_{z2} or just Cu_{z} with the amounts of each material shown in the formulas of FIG. 7A. Formulas are also shown in Table 4 along with some electrochemical data.

TABLE 4
Group 4 Cathode Materials and Electrochemical Results

| | | Final | |
|---|---|---|---|
| | Max | capacity | |
| | Capac- | (@300 | Capacity |
| Sample name | ity | cycles) | Retention |
| Na_{0.95}Mn_{0.5} Ni_{0.4}Fe_{0.1}O₂ | 133.4 | 127.3 | 95.4 |
| Li_{0.05}Na_{0.95}Mn_{0.5}Ni_{0.4}Fe_{0.1}O₂ | 130.8 | — | — |
| Na_{0.92}Mn_{0.5}Ni_{0.3}Fe_{0.1}Cu_{0.1}O₂ | 126.1 | 123.8 | 98.2 |
| Li_{0.08}Na_{0.92}Mn_{0.5}Ni_{0.3}Fe_{0.1}Cu_{0.1}O₂ | 133.9 | 130.4 | 97.4 |
| Na_{0.92}Mn_{0.5}Ni_{0.2}Fe_{0.1}Cu_{0.1}Mg_{0.1}O₂ | 119.4 | 118 | 98.8 |
| Li_{0.08}Na_{0.92}Mn_{0.5}Ni_{0.2}Fe_{0.1}Cu_{0.1}Mg_{0.1}O₂ | 123.2 | 122.9 | 99.8 |

To incorporate a Li dopant, the non lithiated cathodes were mixed with LiOH and subjected to an additional heating step at 645° C. These cathodes and the non-lithium containing cathodes were made into electrodes and electrochemically cycled in a half cell configuration with Sodium metal (Na) as the counter electrode. The cells were cycled from 2-4 V vs. Na⁺/Na for 300 cycles. All samples exhibited excellent cycling stability with little capacity fading within the 300 cycles. The Ni content was reduced from a 0.4 molar fraction to a 0.3 or even 0.2 in some of these cathode formulations. Cathode materials were tested with and without 8% and 5% Li. Without Li, the reversible capacity of Na_{0.92}Mn_{0.5}Ni_{0.3}Fe_{0.1}Cu_{0.1}O₂ and Na_{0.92}Mn_{0.5}Ni_{0.2}Fe_{0.1}Cu_{0.1}Mg_{0.1}O₂ was ~126 and ~119 mAhg⁻¹, respectively. With Li, the reversible capacity for Li_{0.08}Na_{0.92}Mn_{0.5}Ni_{0.3}Fe_{0.1}Cu_{0.1}O₂ and Li_{0.08}Na_{0.92}Mn_{0.5}Ni_{0.2}Fe_{0.1}Cu_{0.1}Mg_{0.1}O₂ increased to ~134 and ~123 mAhg⁻¹, respectively. These cathodes exhibited excellent capacity retention of ≥97% after 300 cycles.

FIG. 7B provides 5th cycle voltage profile plots after for the layered oxide cathodes of FIG. 7A during charging and discharging measured over a 2-4 V vs. Na⁺/Na voltage window such that voltage changes and particularly voltage steps (or lack of steps) associated with the different cathode materials can be seen.

In FIG. 7B, the effect of step smoothening can be clearly seen when comparing Na_{0.92}Mn_{0.5}Ni_{0.3}Fe_{0.1}Cu_{0.1}O₂ & Li_{0.08}Na_{0.92}Mn_{0.5}Ni_{0.3}Fe_{0.1}Cu_{0.1}O₂. This, again, shows that the number of dopants positively effects step suppression. However, for highly doped samples Na_{0.92}Mn_{0.5}Ni_{0.2}Fe_{0.1}Cu_{0.1}Mg_{0.1}O₂ and Li_{0.08}Na_{0.92}Mn_{0.5}Ni_{0.2}Fe_{0.1}Cu_{0.1}Mg_{0.1}O₂, the smoothening affect is not as obvious, but the increase in reversible capacity is noticeable in the cycling data. Similarly, Li as a dopant has a positive impact on reducing voltage steps as can be seen in the voltage profiles for Na_{0.95}Mn_{0.5}Ni_{0.4}Fe_{0.1}O₂ and Li_{0.05}Na_{0.95}Mn_{0.5}Ni_{0.4}Fe_{0.1}O₂.

FIG. 7C provides Cu Kα powder X-ray diffractogram (XRD) plots for the layered oxide cathodes of FIGS. 7A and 7B. After synthesis, the cathode materials were crushed into a fine powder and diffraction measurements were carried out using a Malvern Panalytical Empyrean X-ray diffractometer. In FIG. 7C, non lithiated cathodes are synthesized with Na content of 92% and 95% at 900° C. All samples are either O3 and or mixed with P2 phases with no signs of significant impurity phases present. At these conditions, most samples favor an O3 phase.

### Example Group 5

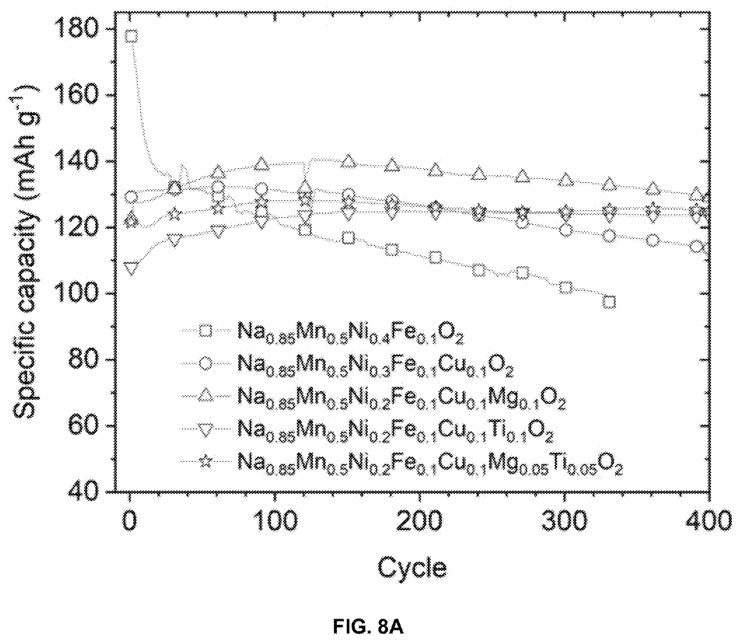

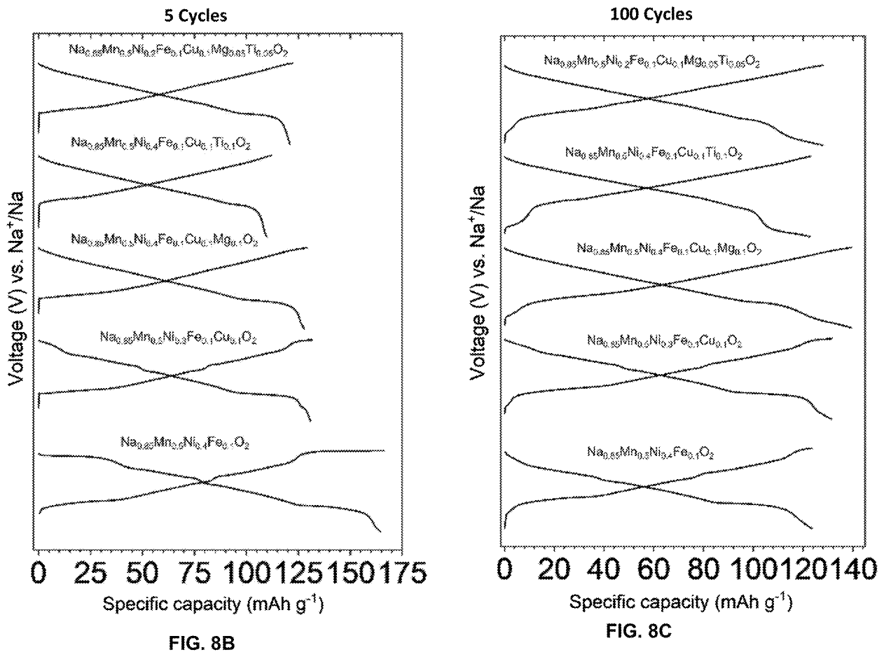

FIG. 8A provides cycling performance (cycling stability) plots of specific capacity for five different layered oxide cathode materials of a fifth cathode material group sintered at a temperature of 900° C. with each measured over a 2.0-4.2 V vs. Na⁺/Na voltage window with each having a composition of Na_{0.85}Mn_{0.5}NiᵥFe_{0.1}φ_{z}O₂, wherein v represents the amount of nickel which ranges from a 0.2 to 0.4 molar fraction, Oz represents Cu_{z1}Mg_{z2} Ti_{z3} with the amounts of each material shown in the formulas of FIG. 8A. Formulas are also shown in Table 5 along with some electrochemical data.

TABLE 5
Group 5 Cathode Materials and Electrochemical Results

| | | Capac- | |
|---|---|---|---|
| | Max | ity | |
| | Capac- | @300 | Capacity |
| | ity | cycles | Retention |
| | (mAh | (mAh | @300 |
| Sample name | g⁻¹) | g⁻¹) | cycles (%) |
| Na_{0.85}Mn_{0.5}Ni_{0.4}Fe_{0.1}O₂ | 177.7 | 102.42 | 57.6 |
| Na_{0.85}Mn_{0.5}Ni_{0.3}Fe_{0.1}Cu_{0.1}O₂ | 132.3 | 119.3 | 86.4 |
| Na_{0.85}Mn_{0.5}Ni_{0.4}Fe_{0.1}Cu_{0.1}Mg_{0.1}O₂ | 140.5 | 134.1 | 95.3 |
| Na_{0.85}Mn_{0.5}Ni_{0.4}Fe_{0.1}Cu_{0.1}Ti_{0.1}O₂ | 124.9 | 124.2 | 99.5 |
| Na_{0.85}Mn_{0.5}Ni_{0.2}Fe_{0.1}Cu_{0.1}Mg_{0.05}Ti_{0.05}O₂ | 128.2 | 124.8 | 97.5 |

The effect of dopants becomes even more evident during extended cycling. As shown in FIG. 8A, the baseline MNF cathode reaches a capacity retention of only 56% after 300 cycles, whereas the single-doped (Cu) and multidoped MNF (Mg/Cu, Mg/Ti, Cu/Mg/Ti) cathodes achieve capacity retentions of 85% and >95%, respectively, over the same number of cycles

FIG. 8B provides 5th cycle voltage profile plots for the five layered oxide cathodes of FIG. 8A during charging and discharging measured over a 2-4.2 V vs. Na⁺/Na voltage window such that voltage changes and particularly voltage steps (or lack of steps) associated with the different cathode materials can be seen.

FIG. 8C provides 100th cycle voltage profile plots for the five layered oxide cathodes of FIG. 8A during charging and discharging measured over a 2-4.2 V vs. Na⁺/Na voltage window such that voltage changes and particularly voltage steps (or lack of steps) associated with the different cathode materials can be seen.

The impact of high-voltage cycling is further illustrated by the voltage profiles in FIG. 8B after 5 cycles, the baseline MNF cathode exhibits the characteristic high-voltage plateau at ~4.2 V associated with the detrimental 01 phase transition, while this plateau is significantly suppressed in the doped samples. After 100 cycles, the high-voltage plateau in the baseline MNF is substantially diminished and exhibits rapid capacity decay. On the other hand, the voltage profiles for doped samples retain their shape over the same number of cycles and do not exhibit such accelerated capacity fading. This extended cycling data confirms the enhanced structural reversibility of the doped-MNF when compared to the baseline and emphasizes the role of dopants in stabilizing the layered structure during extended cycling.

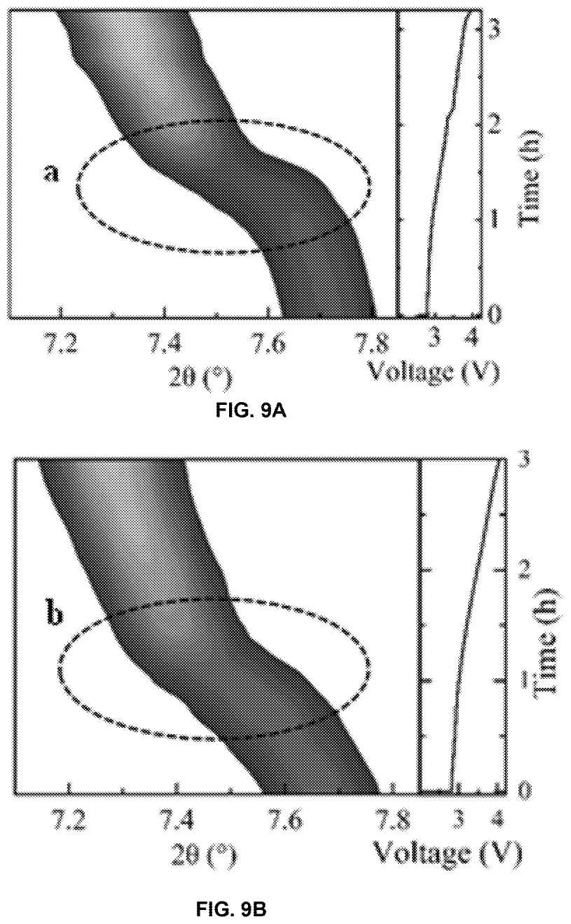

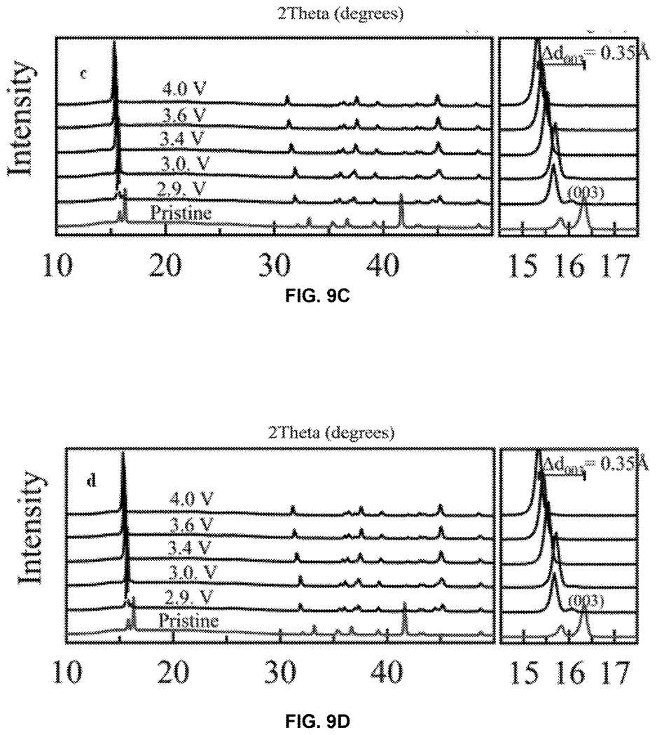

FIGS. 9A and 9B provide in situ X-ray diffraction (XRD) contour plots along with corresponding electrochemical performance plots for MNF (e.g., Na_{0.85}Mn_{0.5}Ni_{0.4}Fe_{0.1}O₂) and MNFCM (e.g., Na_{0.85}Mn_{0.5}Ni_{0.2}Fe_{0.1}Cu_{0.1}Mg_{0.1}O₂) respectively where the Na and the O₂ are not set forth in the short hand notation but are assumed to be present.

FIGS. 9C and 9D provide ex situ XRD contour plots of MNF and MNFCM, respectively at different states of charge during charging to 4.0 V with the panels on the right of each showing the corresponding magnified (001) region.

Multi-element doping alters the structural evolution of the O3-type MNF framework during electrochemical reactions, resulting in smoother voltage profiles and the suppression of detrimental phase transitions.

In the baseline MNF sample, the structural evolution between 2.0 and 4.0 V proceeds through a multistep phase transformation. During the initial stage of charge, the O3-MNF phase transforms into a distorted O′3 phase, as indicated by the feature marked by the dashed oval in FIG. 9A. This transition occurs through a biphasic reaction, evidenced by the plateau observed between 7.4 and 7.6° in the contour plots marked by dotted circle. Upon further Na extraction, the O′3 phase subsequently transforms into a new hexagonal P3 phase, which remains stable up to 4.0 V. The overall O3→O′3→P3 sequence is associated with gliding of the transition-metal-oxide slabs and is accompanied by a 6.5% increase in d-spacing.

In contrast, the multi-element doped MNF samples can exhibit a more gradual and structurally coherent phase evolution. Using (1) Mg & Cu doped MNF (MNFCM) and (2) Mg, Cu, and Ti doped MNF (i.e., MNFCMT (e.g., Na_{0.85}Mn_{0.5}Ni_{0.2}Fe_{0.1}Cu_{0.1}Mg_{0.05}Ti_{0.05}O₂)) as examples, instead of passing through the intermediate O′3 distortion, the doped material undergoes a direct O3→P3 transition, this is characterized by smooth voltage transition in the contour plots. The initial O3 phase first evolves through a single-phase reaction, followed by conversion to P3, as reflected by the gradual and continuous peak shift as indicated by dashed oval in the contour plot during the initial charge (FIG. 9B). This O3→P3 process is accompanied by a slightly smaller d-spacing increase of 5% and 4.8% for MNFCM and MNFCMT respectively. Despite the difference in transition pathway, both materials have very comparable electrochemical reactions between these oxide phases and the electrolyte. Similar electrochemical stability observed for MNF and the doped MNF over this voltage range is a result of the synergetic effect of structural evolution and the interaction with electrolyte, which determines the battery cycling life.

In summary FIGS. 9A-9D indicate that between 2.0 and 4.0 V, MNF undergoes a multistep O3→O′3→P3 phase transition, which is characterized by distinct voltage steps in the voltage curves. By contrast, multielement doping (FIGS. 9B and 9D) suppresses NiO6 Jahn-Teller distortion and minimizes d-spacing expansion, leading to more gradual structural evolution and a smoother electrochemical voltage profile.

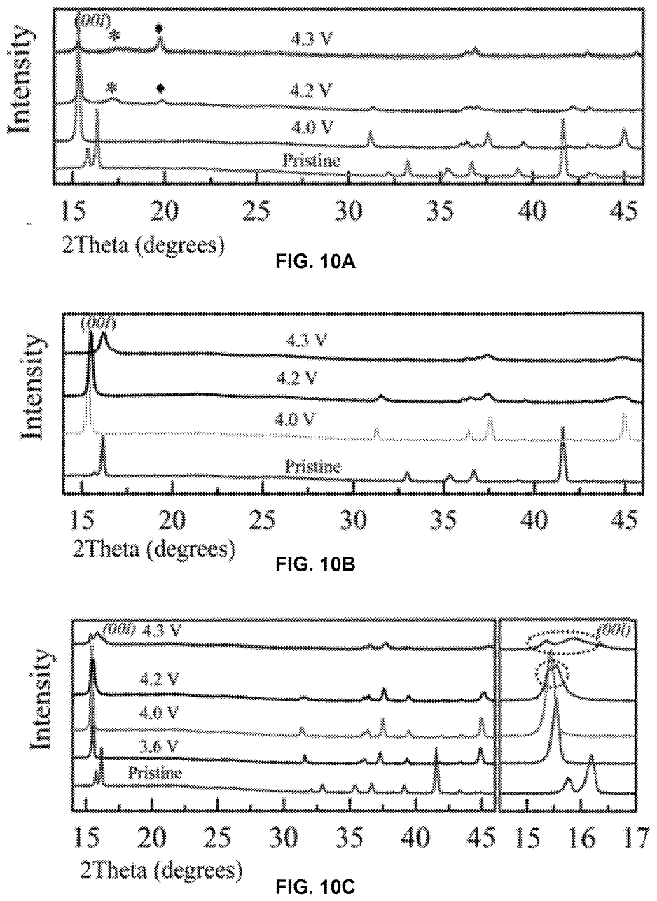

FIGS. 10A, 10B, and 10C respectively provide ex situ XRD plots of MNF, MNFCM, and MNFCMT at different states of charge with FIG. 10C also providing a magnified view of the (001) region. The diamond symbol near 20° in FIG. 10A marks the major O1 reflection peak, while the dotted circle highlights the magnified (001) reflection region of the OP2 phase in MNFCMT.

To improve the energy density of sodium-ion batteries, it can be useful to extend the upper cutoff voltage above 4.0 V. The structural evolution of baseline MNF and multi-element doped MNF diverges markedly in this high-voltage region (cut-off >4.0 V). According to the Ex-situ XRD measurements collected between 4.0 and 4.3 V, the baseline MNF undergoes a distinct high-voltage phase transition around 4.1 V, consistent with the flat voltage plateau observed in the electrochemical profiles. This is a characteristic of a first-order transformation of P3→O1 transition, as confirmed by the structural analysis at 4.2 V in FIG. 10A (diamond-marked reflections). This P3→O1 transition is accompanied by a pronounced contraction of the c-lattice parameter, with the d-spacing decreasing by nearly 22%. Such substantial lattice shrinkage is highly detrimental, as it imposes severe mechanical stress on the layered framework during repeated charge-discharge cycling.

In contrast, multi-element doping effectively suppresses O1 formation and fundamentally alters the phase-evolution pathway at high-voltage (above 4.0 V). Rather than undergoing the destructive P3→O1 transition observed in baseline MNF, the doped samples transforms from P3 to OP2 (FIG. 10B), where OP2 represents an O/P-type intergrowth structure. This phase transition is accompanied by only a 5% and 2.6% decrease in d-spacing for MNFCM and NMFCMT respectively, which is substantially smaller than the contraction observed in the baseline material. These results clearly show that the dopants do not merely suppress a detrimental phase transition but actively modulate the crystal structure to favor a more coherent and less disruptive high-voltage structural phase. Such dopant-induced structural modulation is therefore advantageous for stabilizing the layered framework at high-voltages.

In summary, FIGS. 10A-10C indicate that when charged to high voltage, MNF exhibits a complex phase transition from O3→O′3→P3→O1. The P3→O1 transition is accompanied by pronounced shrinkage in the c lattice parameter, whereas multi-element doping effectively suppresses O1 phase formation and preserves structural stability with minimal lattice change.

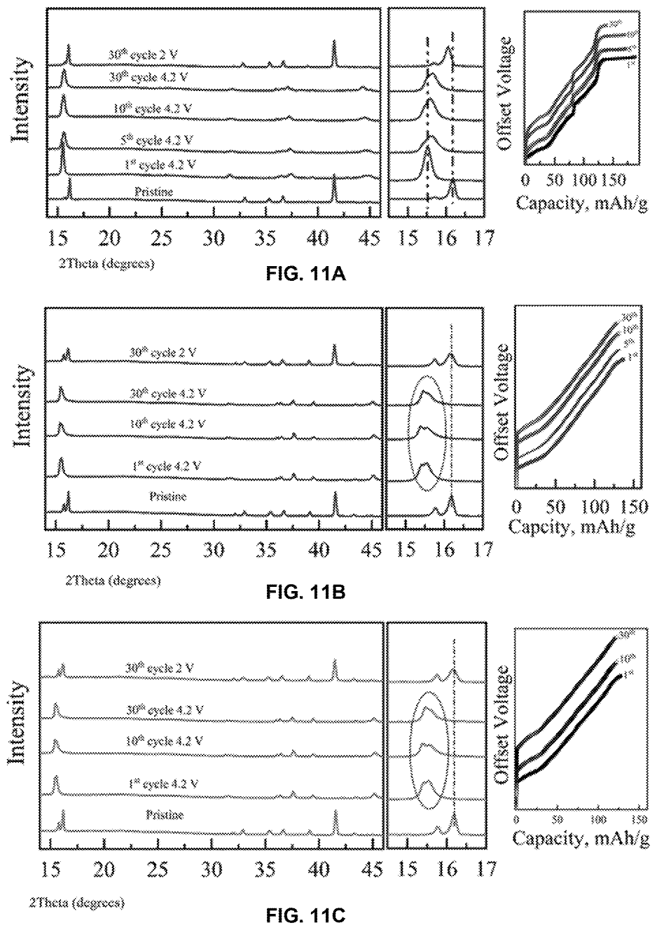

FIGS. 11A, 11B, and 11C respectively provide XRD plots of MNF, MNFCM, and MNFCMT to the left and offset voltage profiles to the right when cycled between 2.0 and 4.2 V and stopped at either the charged state (4.2 V) or discharged state (2.0 V) after 1^{st}, 5^{th} (FIGS. 11A and 11B only), 10^{th}, and 30^{th} various cycles.

To further elucidate the structural reversibility of the baseline MNF and doped-MNF electrodes, ex situ XRD patterns were compared for cells cycled between 2.0 and 4.2 V and stopped at either the charged state (4.2 V) or discharged state (2.0 V) after the 1st, 5^{th}, 10^{th}, and 30^{th} cycles. In baseline MNF, the 01 phase that emerges at 4.2 V during the first charge becomes increasingly pronounced upon subsequent cycling, as reflected by the increasing intensity of the O1-related diffraction peak from the 1st to the 10th cycle. By the 30th cycle, the charged-state XRD pattern no longer exhibits the O1 diffraction peaks and is instead dominated by P3 reflections. Furthermore, the P3 (001) reflections are shifted slightly to higher angles relative to the P3 phase observed at 4.0 V in the first cycle, indicating that even less Na is extracted than in the initial cycle at 4.0 V. The disappearance of the 01 phase at high voltage strongly suggests that the structure can no longer sustain the extent of Na⁺ ion extraction achieved during the initial cycles, due to cumulative structural damage. This is supported by electrochemical data (FIG. 11A) which show pronounced capacity fading for MNF under a 4.2 V cutoff, with the loss arising predominantly from the high-voltage capacity contribution, as evidenced by comparison of the 1st, 5th, 10th, and 30th voltage-charge profiles. Although the O3 phase is recovered upon discharge even in the 30th cycle, the inability to re-form the 01 phase at high voltage clearly points to growing structural irreversibility at high voltage.

In contrast, the doped-MNF electrode exhibits markedly improved structural reversibility, highlighting the critical role of dopant-induced structure modulation in stabilizing the layered framework during extended cycling. According to Ex situ XRD patterns, the doped material cycled under similar conditions reveal persistent and highly reversible evolution of the OP2 phase at high voltage, without the formation of the detrimental 01 phase, even after 30 cycles. The O3→P3→OP2 pathway is more reversible as the OP2 phase suppresses the severe slab rearrangement associated with O1 formation in the undoped material. Equally important, the discharged doped samples recover the original O3 framework even after prolonged cycling, with only a slight peak shift, consistent with a largely solid solution reaction mechanism in this compositional and voltage region.

In summary, FIGS. 11A-11C indicate that baseline MNF shows rapid capacity fading during cycling, particularly in the high-voltage region (2.0-4.2 V). XRD analysis indicates that this degradation arises from irreversible structural changes caused by repeated lattice expansion and contraction. In contrast, doped MNF samples exhibit improved structural reversibility, leading to better high-voltage capacity retention and overall cycling performance.

### Additional Remarks

Any materials referenced herein are incorporated herein by reference as if set forth in full. To the extent that any definitions or other teachings set forth in material incorporated herein by reference contradict teachings set forth directly herein (i.e., not incorporated by reference), the order of precedence given to the definitions or other teachings are: (1) teachings set forth directly in the body of the application, (2) teachings set forth in any incorporated materials having more recent dates, and then teachings set forth in any incorporated materials having earlier dates.

It is intended that the aspects of the invention set forth specifically herein or otherwise ascertained from the present teachings represent independent invention descriptions which Applicant contemplates as full and complete, and that Applicant believes may be set forth as independent claims without need of importing additional limitations or elements from other embodiments or aspects set forth herein for interpretation or clarification. It is also understood that any variations of the aspects (as well as variations within or between any embodiments) set forth herein represent individual and separate features that may form separate claims or be individually added to claims to further define an invention to the extent that such combinations remain functional.

While various preferred embodiments of the invention are shown and described, it is to be understood that this invention is not limited thereto but may be variously embodied to practice within the scope of the following claims and within the gist of the teachings as a whole as set forth herein. From the foregoing and subsequent descriptions, it will be apparent that various changes may be made without departing from the spirit and scope of the invention.

1. A layered oxide SIB cathode comprising a layered crystalline lattice structure, comprising a composition of A_{w}NaᵤMnₓNiᵥFe_{y}φ_{z}O₂,
wherein Na, Mn, Ni, Fe, and O represent elements;
wherein 0<=w<=0.4;
wherein 0.6<=u<=1.0;
wherein 0.2<=x<=1;
wherein 0<=v<=0.4;
wherein 0<=y<=0.4;
wherein 0<=z<=0.4;
wherein φ comprises at least one element selected from the group consisting of: (a) Cu, (b) Mg, (c) Ti, (d) Cr, (e) Zn, (f) Li, (g) K, (h) Ca, (i) Al, (j) B, (k) Sn, (I) Sb, (m) V, (n) Zr, (o) Mo, (p) Ru, (q) Bi;
wherein A represents at least one element selected from the group consisting of: (i) Ca, (ii) Li, (iii) K, and (iv) B;
wherein φ and A are place holders for elements located within separate layers of the crystalline lattice of the layered cathode; and
wherein at least one of (1) z is greater than zero such that at least one element of the group of (a)-(q) is present, (2) w is greater than zero such that at least one element of group (i)-(iv) is present, or (3) both x and w are non-zero such that at least one element of group (a)-(q) and at least one element of group (i)-(iv) are present.

2. The layered oxide SIB cathode of claim 1 wherein x+v+y+z=1.

3. The layered oxide SIB cathode of claim 1 wherein z does not equal zero for at least one element of the group of (a)-(q).

4. The layered oxide SIB cathode of claim 1 wherein z does not equal zero for at least two elements of the group of (a)-(q).

5. The layered oxide SIB cathode of claim 1 wherein z does not equal zero for at least three elements of the group of (a)-(q).

6. The layered oxide SIB cathode of claim 1 wherein z does not equal zero for more than three elements of the group of (a)-(q).

7. The layered oxide SIB cathode of claim 1 wherein w does not equal zero for at least one element of the group of (i)-(iv).

8. The layered oxide SIB cathode of claim 1 wherein w does not equal zero for at least two elements of the group of (i)-(iv).

9. The layered oxide SIB cathode of claim 1 wherein A_{w}NaᵤMnₓNiᵥFe_{y}φ_{z}O₂ is selected from the group consisting of:
(A) A_{w}NaᵤMnₓNiᵥFe_{y}φ_{z}O₂, with w=0, with φ being Mg, and with z>0;
(B) A_{w}NaᵤMnₓNiᵥFe_{y}φ_{z}O₂ with w=0, with φ=Cu, and with z>0;
(C) A_{w}NaᵤMnₓNiᵥFe_{y}φ_{z}O₂ with w=0, with φ=Ti, and with z>0;
(D) A_{w}NaᵤMnₓNiᵥFe_{y}φ_{z}O₂ with w=0 and with φ_{z} being Cu_{z1}Mg_{z2}, and with z1>0 and z2>0;
(E) A_{w}NaᵤMnₓNiᵥFe_{y}φ_{z}O₂ with w=0 and with φ_{z} being Cu_{z1}Ti_{z2}, and with z1>0 and z2>0;
(F) A_{w}NaᵤMnₓNiᵥFe_{y}φ_{z}O₂ with w=0 and with φ_{z} being Mg_{z1}Ti_{z2}, and with z1>0 and z2>0;
(G) A_{w}NaᵤMnₓNiᵥFe_{y}φ2O₂ with w=0, and with φ_{z} being Cu_{z1}Mg_{z2}Ti_{z3}, and with z1>0, z2>0, and z3>0
(H) A_{w}NaᵤMnₓNiᵥFe_{y}φ_{z}O₂ with A=Li, with w>0, and with z=0;
(I) A_{w}NaᵤMnₓNiᵥFe_{y}φ_{z}O₂ with A being Li, w>0, with φ being Cu, and z>0, and
(J) A_{w}NaᵤMnₓNiᵥFe_{y}φ_{z}O₂ with A being Li, with w>0, with φ_{z} being Cu_{z1}Mg_{z2} and with z1>0, and z2>0.

10. The layered oxide SIB cathode of claim 1 wherein A_{w}NaᵤMnₓNiᵥFe_{y}φ_{z}O₂ is selected from the group consisting of:
(A) Na_{0.85}Mn_{0.5}Ni_{0.3}Fe_{0.1}Mg_{0.1}O₂, with w=0, and with φ being Mg;
(B) Na_{0.85}Mn_{0.5}Ni_{0.3}Fe_{0.1}Cu_{0.1}O₂ with w=0 and with φ=Cu;
(C) Na_{0.85}Mn_{0.5}Ni_{0.3}Fe_{0.1}Ti_{0.1}O₂ with w=0 and with φ=Ti;
(D) Na_{0.85}Mn_{0.5}Ni_{0.2}Fe_{0.1}Cu_{0.1}Mg_{0.1}O₂ with w=0 and with φ_{z} being Cu_{z1}Mg_{z2};
(E) Na_{0.85}Mn_{0.5}Ni_{0.2}Fe_{0.1}Cu_{0.1}Ti_{0.1}O₂ with w=0 and with φ_{z} being Cu_{z1}Ti_{z2};
(F) Na_{0.85}Mn_{0.5}Ni_{0.2}Fe_{0.1}Mg_{0.1}Ti_{0.1}O₂ with w=0 and with φ_{z} being Mg_{z1}Ti_{z2};
(G) Na_{0.85}Mn_{0.5}Ni_{0.2}Fe_{0.1}Mg_{0.05}Cu_{0.1}Ti_{0.05}O₂ with w=0 and φ_{z}=Mg_{0.05}Cu_{0.1}Ti_{0.05};
(H) Na_{0.92}Mn_{0.5}Ni_{0.3}Fe_{0.1}Mg_{0.1}O₂, with w=0, and with φ being Mg;
(I) Na_{0.92}Mn_{0.5}Ni_{0.3}Fe_{0.1}Cu_{0.1}O₂ with w=0 and with φ=Cu;
(J) Na_{0.92}Mn_{0.5}Ni_{0.3}Fe_{0.1}Ti_{0.1}O₂ with w=0 and with φ=Ti;
(K) Na_{0.92}Mn_{0.5}Ni_{0.2}Fe_{0.1}Cu_{0.1}Mg_{0.1}O₂ with w=0 and with φ_{z} being Cu_{z1}Mg_{z2};
(L) Li_{0.05}Na_{0.95}Mn_{0.5}Ni_{0.4}Fe_{0.1}O₂ with A=Li, w=0.05, and with z=0;
(M) Li_{0.08}Na_{0.92}Mn_{0.5}Ni_{0.3}Fe_{0.1}Cu_{0.1}O₂ with A=Li, w=0.08, and with φ_{z} being Cu_{z}; and
(N) Li_{0.08}Na_{0.92}Mn_{0.5}Ni_{0.2}Fe_{0.1}Cu_{0.1}Mg_{0.1}O₂ with A=Li, w=0.08, and with φ_{z} being Cu_{z1}Mg_{z2}.

11. The layered oxide SIB cathode of claim 1 wherein z=z_{z1}, zᵢ is non-zero for at least one selected element of (a)-(q) of claim 1 when φ=φ1_{z1} . . . φr_{zn}, and zᵢ, for at least one non-zero zᵢ, is within a range selected from the group of: (A) 0<zᵢ<=0.4, (B) 0<=zᵢ<=0.3, (C) 0<=zᵢ<=0.2, (D) (I) 0<zᵢ<=0.1, (E) 0.25<=zᵢ<=0.4, (F) 0.025<=zᵢ<=0.3, (G) 0.025<=zᵢ<=0.2, (H) 0.025<=zᵢ<=0.1, (I) 0.05<=zᵢ<=0.4, (J) 0.0.5<=zᵢ<=0.3, (K) 0.05<=zᵢ<=0.2, (L) an 0.05<zᵢ<=0.1.

12. The layered oxide SIB cathode of claim 11 wherein the at least one selected element of (a)-(q) is a plurality of elements of (a)-(q).

13. The layered oxide SIB cathode of claim 1 wherein w=Σwᵢ, wherein wᵢ is non-zero for at least one selected element of (i)-(iv) of claim 1 when A=A1_{w1} . . . An_{wn}, and wherein wᵢ, for at least one non-zero wᵢ, is within a range selected from the group of: (A) 0<wᵢ<=0.2, (B) 0<wᵢ<=0.1, (C) 0<wᵢ<=0.08, (D) 0<wᵢ<=0.05, (E) 0<wᵢ<=0.025; (F) 0.025<=wᵢ<=0.2, (G) 0.025<=wᵢ<=0.1; (H) 0.025<=wᵢ<=0.08; (i) 0.025<=wᵢ<=0.05; (j) 0.05<=wᵢ<=0.2; (k) 0.05<=wᵢ<=0.1, and (L) 0.05<=wᵢ<=0.08.

14. The layered oxide SIB cathode of claim 13 wherein the wherein the at least one selected element of (i)-(iv) is a plurality of elements of (i)-(v).

15. The layered oxide SIB cathode of claim 1 wherein u is within a range selected from the group consisting of: (I) 0.6<=u<=1, (II) 0.6<=u<=0.95, (III) 0.6<=u<=0.92, (iv) 0.6<=u<=0.85, (v) 0.85<=u<=1.0, (vi) 0.85<=u<=0.95, (vii) 0.85<=u<=0.92, and (viii) 0.92<=u<=0.96.

16. The layered oxide SIB cathode of claim 1 wherein x is within a range selected from the group consisting of: (I) 0.2<=x<=1; (II) 0.3<=x<=0.9, (III) 0.4<=x<=0.8; (IV) 0.4<=x<=0.7; (V) 0.4<=x<=0.6; and (VI) 0.45<=x<=0.55.

17. The layered oxide SIB cathode of claim 1 wherein v is within a range selected from the group consisting of: (I) 0<=v<=0.4; (II) 0.05<=v<=0.35; (III) 0.05<=v<=0.3; (III) 0.05<=v<=0.25; (IV) 0.5<=v<=0.2; (V) 0.5<=v<=0.15; (VI) 0.1<=v<=0.4; (VII) 0.1<=v<=0.35; (VIII) 0.1<=v<=0.3; (VIII) 0.1<=v<=0.25; (IX) 0.1<=v<=0.2; (X) 0.15<=v<=0.35; (XI) 0.15<=v<=0.3; (XII) 0.15<=v<=0.25; (XIII) 0.2<=v<=0.35; (XIV) 0.2<=v<=0.3; and (XV) 0.25<=v<=0.35.

18. The layered oxide SIB cathode of claim 1 wherein y is within a range selected from the group consisting of: (1) 0<=y<=0.4; (II) 0.05<=y<=0.35; (III) 0.05<=y<=0.3; (III) 0.05<=y<=0.25; (IV) 0.5<=y<=0.2; and (V) 0.5<=y<=0.15.

19. A sodium-ion battery, comprising:
(a) an anode;
(b) a layered oxide cathode of claim 1;
(c) an electrolyte; and
(d) a separator.
